(19) United States
(12) Patent Application Publication
(10) Pub. No.: US 2026/0164481 A1
(43) Pub. Date: Jun. 11, 2026

(54) Methods for Heterogeneous Multihop UE-to-UE Relay Discovery and Link Establishment

(71) Applicant: InterDigital Patent Holdings, Inc., Wilmington, DE (US)

(72) Inventors: Joe HUANG, Montville, NJ (US); Samir FERDI, Kirkland, CA (US); Jung Je SON, Warrington, PA (US); Sudhir PATTAR, Mount Laurel, NJ (US); Kyle Jung-Lin PAN, Saint James, NY (US); Philip LEITHEAD, King of Prussia, PA (US)

(73) Assignee: InterDigital Patent Holdings, Inc., Wilmington, DE (US)

(21) Appl. No.: 18/962,014

(22) Filed: Nov. 27, 2024

(51) Int. Cl. H04W 76/14; H04W 88/04

(52) U.S. Cl. CPC H04W 76/14; H04W 88/04

(57) ABSTRACT

A WTRU receives a hybrid node configuration information comprising an indication for the WTRU to perform as a WTRU-to-WTRU relay and an end WTRU. The WTRU receives a first message comprising at least one direct discovery set, which comprises a list of end WTRU user information IDs of end WTRUs. The first message comprises a list of previous hops routing information for each end WTRU that indicates a sequence of user information IDs of WTRU-to-WTRU relays associated with an end WTRU. The first message comprises a list of hop counts for each end WTRU in the list of end WTRUs. The WTRU stores a route to each end WTRU in a direct discovery routing table based on the previous hops routing information. The WTRU sends a second message to a second WTRU-to-WTRU relay that comprises the at least one direct discovery set and end WTRU user information IDs.

### STATEMENT OF GOVERNMENT RIGHTS

This invention was made with Government support under Contract No. N00014-21-C-1080 awarded by the Office of Naval Research. The Government has certain rights in the invention.

### BACKGROUND

5G ProSe defined several features and procedures such as 5G ProSe Direct Discovery, 5G ProSe Direct Communication, 5G ProSe UE-to-Network (U2N) Relay, and 5G ProSe UE-to-UE (U2U) Relay. 5G ProSe UE-to-UE Relay enables indirect communication between two End UEs. For a UE-to-UE Relay, 5G ProSe UE-to-UE Relay Discovery and 5G ProSe Communication via UE-to-UE Relay are defined.

For 5G ProSe UE-to-UE Relay Discovery, both Model A and Model B discovery are supported: Model A uses a single discovery protocol message (Announcement). Model B uses two discovery protocol messages (Solicitation and Response). Discovery integrated into a PC5 unicast link establishment procedure is supported.

5G ProSe Communication via a UE-to-UE Relay is possible with a Layer 2 UE-to-UE Relay or a Layer3 UE-to-UE Relay. For a Layer 2 UE-to-UE Relay and Layer3 UE-to-UE Relay, 5G ProSe communication setup with discovery procedures is defined. Discovery integrated into a PC5 unicast link establishment procedure is defined.

With a Layer2 UE-to-UE Relay, an end-to-end PC5 link is established between the End UEs via the Relay. PC5-S messages may then be exchanged between End UEs.

With a Layer3 UE-to-UE Relay, each End UE establishes a PC5 link with the Relay and the Relay forwards messages towards End UEs. PC5-S messages are exchanged between End UEs and the Relay.

With a Layer3 UE-to-UE Relay, when an IP based data connection is used, after a PC5 link is setup with the Relay, each End UE may be assigned an IP address by the Relay which may be based on a Dynamic Host Configuration Protocol (DHCP) procedure or each End UE may assign its own IP address, which may be based on a link local IP address assignment procedure and inform the Relay. Whether a DHCP or link local IP address assignment is used is determined during a security connection setup between an End UE and the UE-to-UE Relay.

### SUMMARY

A method and a wireless transmit/receive unit (WTRU) for performing the method are disclosed. A WTRU may be configured to receive a hybrid node configuration information. The hybrid node configuration information may comprise an indication for the WTRU to perform as a WTRU-to-WTRU relay and an end WTRU. The WTRU may be configured to receive a first message from a first WTRU-to-WTRU relay. The first message may comprise at least one direct discovery set. The at least one direct discovery set may comprise a list of end WTRU user information identifications (IDs) of end WTRUs. The first message may comprise a list of previous hops routing information for each end WTRU that indicates a sequence of user information IDs of WTRU-to-WTRU relays associated with an end WTRU. The first message may comprise a list of hop counts for each end WTRU in the list of end WTRUs.

The WTRU may be configured to process the first message. The processing of the first message may comprise storing a route to each end WTRU in a direct discovery routing table based on the previous hops routing information.

The WTRU may be configured to send a second message to a second WTRU-to-WTRU relay. The second message may comprise the at least one direct discovery set. The at least one direct discovery set may comprise a list of end WTRU user information identifications (IDs) of end WTRUs. The WTRU may announce itself as an end WTRU by including its end WTRU user information ID in the at least one direct discovery set in the second message.

The WTRU may be associated with a WTRU-to-WTRU relay user information identification (ID) as a relay WTRU. The WTRU may be associated with an end WTRU user information ID as an end WTRU. The WTRU may be configured to send capability information to a network node. The capability information may indicate a capability for the WTRU to perform as a WTRU-to-WTRU relay and an end WTRU. The WTRU may be configured to receive the hybrid node configuration information in response to sending the capability information. The at least one direct discovery set may be protected based on direct discovery security materials associated with a ProSe direct discovery service for restricted ProSe direct discovery. The first message may be a first WTRU-to-WTRU relay discovery announcement message. The second message may be a second WTRU-to-WTRU relay discovery announcement message. The WTRU may be provisioned with direct discovery security materials associated with a ProSe direct discovery service for restricted ProSe direct discovery. The WTRU may be configured to process the first message by processing the at least one direct discovery set using the direct discovery security materials. The WTRU may provide, for a destination end WTRU in the direct discovery routing table: a user information ID of the destination end WTRU, a source layer-2 ID associated with the destination end WTRU, a number of hops to the destination end WTRU, and a next hops routing information, wherein the next hops routing information is set to the previous hops routing information in reverse order. The previous hops routing information may comprise a sequence of user information IDs of U2U relays associated with an announcing end WTRU accumulated hop by hop from a closest previous end WTRU when propagating a WTRU-to-WTRU relay discovery message. A closest previous end WTRU may be an intermediate hybrid WTRU or the announcing end WTRU. The WTRU may be configured to process the first message by updating a route to an end WTRU in the direct discovery routing table based on a minimum hop count value or a channel quality of the received first message.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example configuration for heterogeneous multihop UE-to-UE Relay Discovery (Model A);

FIG. 3 shows an example of a heterogeneous multihop UE-to-UE Relay Discovery (Model A) procedure;

FIG. 4 shows an example method for heterogeneous multihop UE-to-UE (U2U) relay discovery for use by a hybrid node UE;

FIG. 5 shows an example configuration for heterogeneous multihop UE-to-UE Relay Discovery (Model B);

FIG. 6 shows an example of a heterogeneous multihop UE-to-UE Relay Discovery (Model B) procedure;

FIG. 7 shows an example method for heterogeneous multihop UE-to-UE (U2U) relay discovery for use by a hybrid node UE;

FIG. 8 shows an example configuration for heterogeneous multihop UE-to-UE Relay Link Establishment;

FIG. 9 shows an example heterogeneous multihop UE-to-UE Relay Link Establishment procedure;

FIG. 10 shows an example method for a heterogeneous multihop UE-to-UE Relay Link Establishment; and

FIG. 11 shows an example multihop UE-to-UE Relay Link Establishment with partial Integrated Discovery.

### DETAILED DESCRIPTION

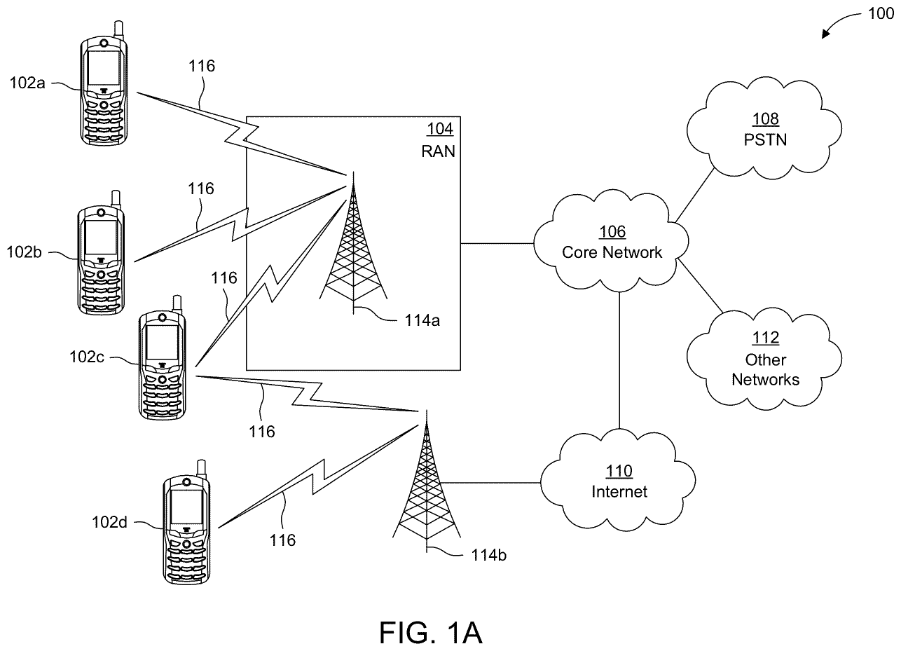

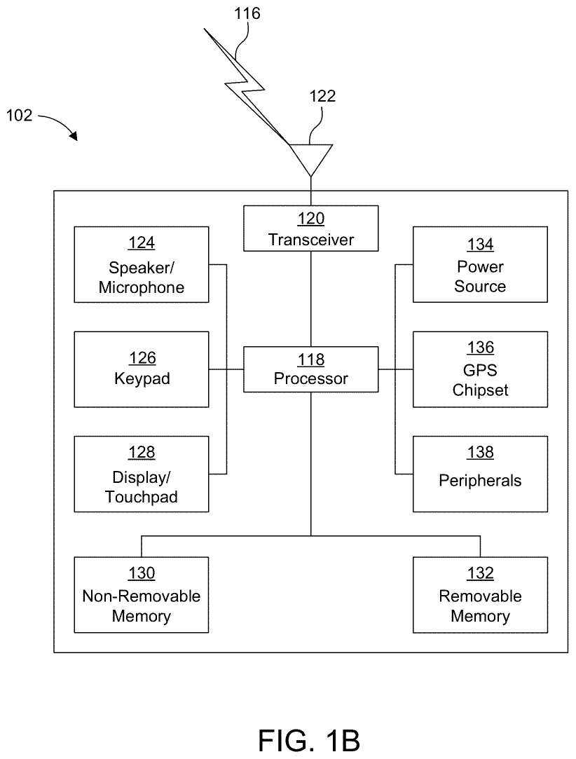

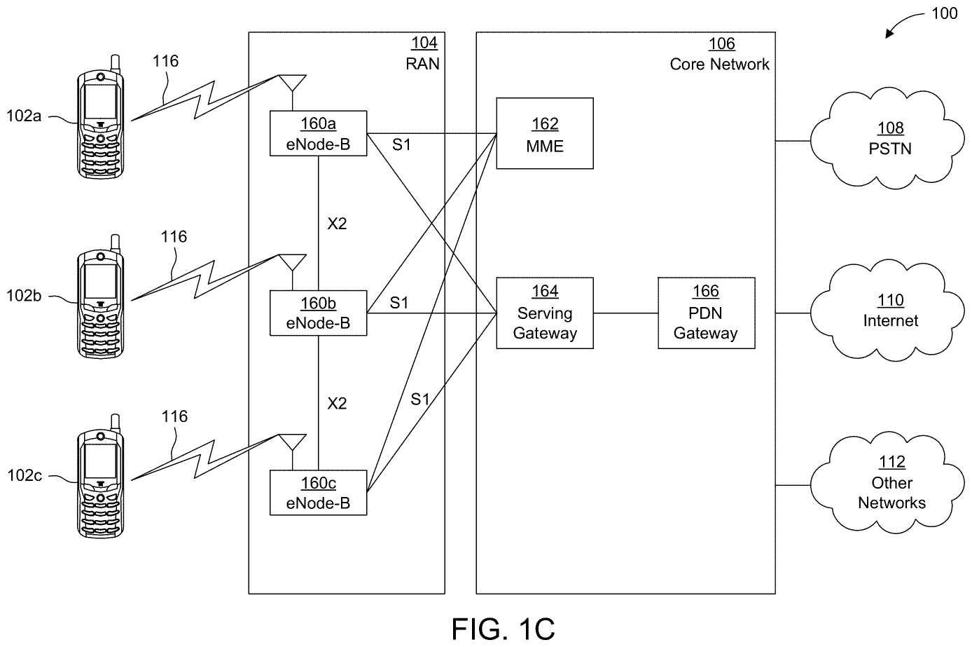

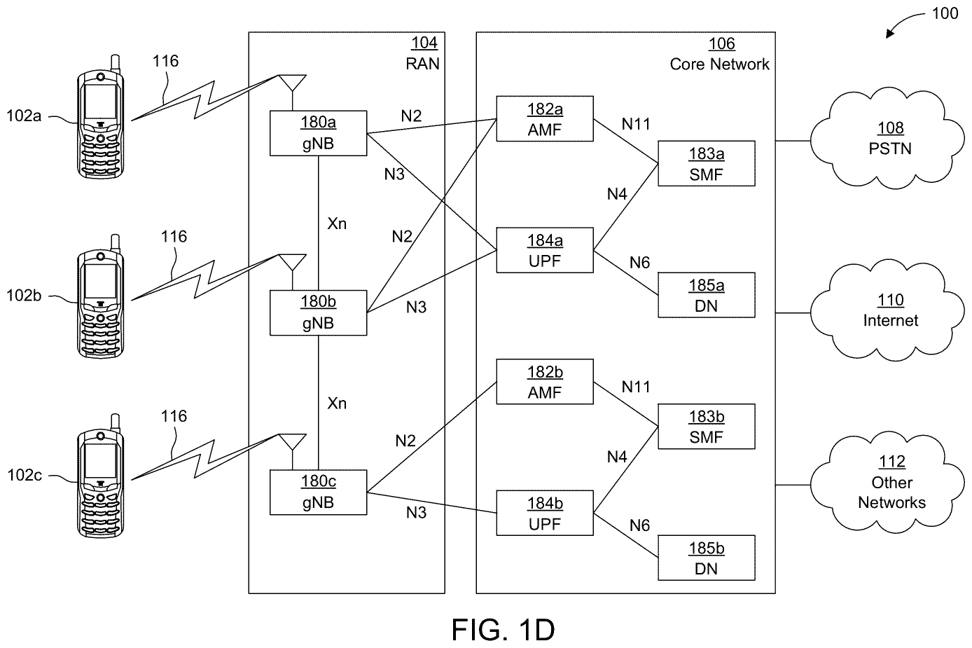

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160csubstantially simultaneously. In the non-standalone configuration, eNode-Bs 160a, 160b, 160cmay serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Herein, UE may be used interchangeably with WTRU and a UE-to-UE relay or U2U relay may be used interchangeably with a WTRU-to-WTRU relay or W2W relay.

After a connection setup between two End UEs via a UE-to-UE Relay, each End UE may keep monitoring the channel status of a PC5 link and when a link quality goes below a threshold value, the End UE may select another UE-to-UE Relay for the connection between two End UEs.

For UE-to-UE Relay Reselection, UE-to-UE Relay Discovery procedures may be used or the negotiated 5G ProSe UE-to-UE Relay Reselection procedure may be used.

In the negotiated UE-to-UE Relay Reselection, one End UE may initiate the UE-to-UE Relay Reselection procedure. End UEs may negotiate a new UE-to-UE Relay using the existing connection and establish the communication via the reselected UE-to-UE Relay prior to releasing the communication via the current 5G ProSe UE-to-UE Relay.

Multihop for UE-to-Network (U2N) Relay is to enable a Remote UE to discover and communicate with a U2N Relay via one or more U2U Relays. Multihop UE-to-UE (U2U) Relay is to enable End UEs to discover and communicate with each other via more than one U2U Relay.

The multihop capability is deemed crucial for mission critical communications (e.g., first responders) and in general needed to enhance coverage (e.g., indoor).

For multihop UE-to-UE Relay, a UE provisioned with security materials associated with a direct discovery set may act as an End UE. The direct discovery set includes End UE User Info ID(s) of the announced End UE or discoverer/discoveree End UEs and other parameters and is visible to the authorized End UEs but transparent to U2U Relays. In a Model-A UE-to-UE Relay Discovery procedure, an End UE may act as a monitoring End UE to process the direct discovery set(s) received in a UE-to-UE Relay Discovery Announcement message. In a Model-B UE-to-UE Relay Discovery procedure, an End UE may extract the direct discovery set in a UE-to-UE Relay Discovery Solicitation message to determine if it is the intended discoveree End UE. The receiving End UE responds to the UE-to-UE Relay Discovery Solicitation message only if it is the intended discoveree End UE. Otherwise, the receiving End UE neither responds nor forwards the received Solicitation message.

A UE provisioned with security materials associated with a relay discovery set may act as U2U Relay. The relay discovery set includes U2U Relay User Info ID(s) of the U2U Relays and other parameters and is visible to both authorized U2U Relays and authorized End UEs. In a Model-A UE-to-UE Relay Discovery procedure, a U2U Relay may forward the direct discovery sets of the discovered End UEs in a UE-to-UE Relay Discovery Announcement message, without extracting the information in the direct discovery sets. In a Model-B UE-to-UE Relay Discovery procedure, a U2U Relay may forward a UE-to-UE Relay Discovery Solicitation/Response message without extracting the information in the direct discovery set of the discoverer/discoveree End UEs. Since the direct discovery set(s) are transparent to U2U Relays, a U2U Relay cannot extract the End UE User Info IDs to store the routes to the destination End UEs in a local routing table.

In an embodiment of a mesh configuration, a set of U2U Relays may form a networking cloud to relay traffic for End UEs surrounding the U2U Relay cloud. In this type of mesh configuration, the End UE User Info IDs may be protected from any U2U Relays in the U2U Relay cloud during the UE-to-UE Relay Discovery process and the U2U Relay User Info IDs along the discovered path may be recorded in the UE-to-UE Relay Discovery messages by the U2U Relays for the End UEs to identify the end-to-end path.

In an embodiment of the mesh configuration, at least some of the End UEs may be located inside the U2U Relay cloud. In general, the U2U Relays may be sparsely distributed in some areas of the U2U Relay cloud. In this type of mesh configuration, it is possible that one End UE (e.g., UEa) may be located on the shortest path (in terms of number of nodes, irrespective of currently defined capability) between a pair of other End UEs (e.g., UEb and UEc). However, since UEa is configured as an End UE and does not forward UE-to-UE Relay Discovery messages, UEb and UEc would need to discover a longer path (comprising only of U2U Relays) between each other. In the worst case, if UEa is on the critical path (in terms of node topology, irrespective of currently defined capability) between UEb and UEc, UEb and UEc may not be able to discover each other. This severely limits the UE-to-UE Relay networking capability within the UE-to-UE Relay mesh configuration. Solutions are needed to efficiently perform UE-to-UE Relay Discovery and subsequent Link Establishment in such a heterogeneous UE-to-UE Relay mesh network while preserving a similar level of privacy protection. Solutions are needed to address the limitations and inefficiency of mesh networking using current UE-to-UE Relay functionality while preserving a similar level of privacy protection.

Herein, a UE-to-UE (U2U) Relay may refer to a UE which is authorized and behaves as a Relay UE to forward traffic between End UEs. A (multihop) UE-to-UE Relay Discovery procedure may be performed by an End UE to discover a path to an announced (Model A) or a discoveree End UE (Model B) via one or more U2U Relays.

A multihop UE-to-UE Relay Link Establishment procedure may be used to set up PC5 connection over the end-to-end path. After (multihop) UE-to-UE Relay Discovery, the initiating End UE may establish connectivity or modify an existing PC5 link with a U2U Relay, through a Direct Communication Request (DCR) or a Link Modification Request (LMR). The U2U Relay may establish connectivity with the next U2U Relay along the discovered path, through a DCR or LMR. The process may continue until the connectivity with the target end UE is established.

A direct discovery set may be protected using the discovery security materials associated with the ProSe Direct Discovery service, and may be abbreviated or referred to as direct discovery security materials. The direct discovery set may include End UE User Info ID(s) of one or more End UE(s), and other parameters.

A Direct Discovery Routing Table (per Relay Service Code) may be set up during the UE-to-UE Relay Discovery procedure. Only UEs provisioned with direct discovery security materials may construct a Direct Discovery Routing Table.

Previous hops Routing Information may be the sequence of User Info ID(s) of U2U Relay(s) associated with an End UE accumulated hop-by-hop when propagating the UE-to-UE Relay Discovery (Announcement/Solicitation/Response) messages.

Next hops Routing Information may be the sequence of User Info ID(s) of U2U Relay(s) in reverse order of previous hops Routing Information for the reverse path. Next hops Routing Information for a destination End UE may be stored in the Direct Discovery Routing Table.

Unicast Routing Table (per Relay Service Code) may be used in the PC5 singling plane (PC5-S) and may be set up during a link establishment procedure. Upon the reception of a Link Modification Request (LMR) or in the security procedure after receiving a Direct Communication Request (DCR), a U2U Relay or an End UE may add an entry to the Unicast Routing Table to the source End UE, with Destination set to User Info ID of the source End UE, and next-hop User Info ID/Layer-2 ID set to the sender User Info ID/source Layer-2-ID of the received message. Upon the reception of a Direct Communication Accept (DCA) or Link Modification Accept (LMA), a U2U Relay or an End UE may add an entry to the Unicast Routing Table to the target End UE, with Destination set to User Info ID of the target End UE and next-hop User Info ID/Layer-2 ID set to the sender User Info ID/source Layer-2-ID of the received message.

To efficiently perform UE-to-UE Relay Discovery and subsequent Link Establishment in a heterogeneous UE-to-UE Relay mesh network, an End UE may be further authorized and configured (e.g., via a “hybrid” indication or flag in the UE configuration) to also serve as a U2U Relay. For example, a conventional End UE may process a UE-to-UE Relay Discovery message (i.e., decipher the UE-to-UE Relay Discovery message and the direct discovery set(s) therein). Based on a hybrid node configuration indication in the UE configuration, this End UE (to be termed a hybrid node UE) additionally determines to process the deciphered data as a U2U Relay (e.g., construct routing information based on the deciphered data and forward the UE-to-UE Relay Discovery messages for other End UEs incorporating the routing information). When taking the role of a discoverer or discoveree End UE during the UE-to-UE Relay Discovery process, a hybrid node UE behaves in the same way as a conventional End UE.

Upon receiving a UE-to-UE Relay Discovery Announcement message in the case of Model-A UE-to-UE Relay Discovery, a hybrid node UE may also announce itself as an End UE when sending out its own UE-to-UE Relay Discovery Announcement message. Upon receiving a UE-to-UE Relay Discovery Solicitation message in the case of Model-B UE-to-UE Relay Discovery, a hybrid node UE first extracts the direct discovery set to determine if it is the intended discoveree End UE. If it is not, the hybrid node UE may serve as a U2U Relay for other End UEs according to the relay service code (RSC). The hybrid node UE may also support functionalities beyond those of a conventional End UE and U2U Relay (e.g., construct a “hybrid” routing table, to be termed a Direct Discovery Routing Table, to record the sequence of U2U Relay routing information to other End UEs for relay operation).

A UE may indicate its capability to support the hybrid mode of operation when registering with the network. If authorized by the network, the UE may receive the appropriate configuration indication from the network. The combination of UE reporting its capability to support hybrid mode of operation and configuration indication from the network provide means to support a new hybrid UE functionality while allowing backward compatible functionality with legacy End UEs, who do not send this new capability to the network nor receive hybrid mode configuration indication from the network.

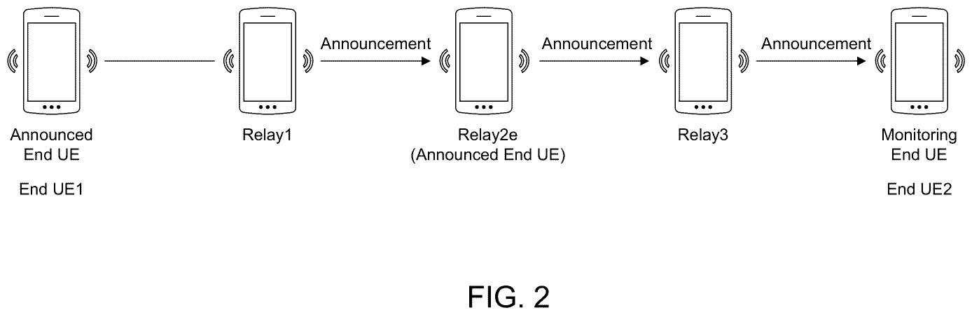

FIG. 2 shows an example configuration for heterogeneous multihop UE-to-UE Relay Discovery (Model A). Relay2e may be authorized and configured as a hybrid node (i.e. an End UE serving as a U2U Relay). A U2U Relay may discover End UEs in proximity and may obtain direct discovery sets of the End UEs. A U2U Relay may announce End UEs in proximity and additional End UEs received from other U2U Relays via UE-to-UE Relay Discovery Announcement messages. An End UE serving as a U2U Relay may announce itself (e.g. End UE User Info ID in the direct discovery set) in the UE-to-UE Relay Discovery Announcement message. A U2U Relay, whether it is an End UE or not, may include its U2U Relay User Info ID in the previous hops Routing Information for each received End UE (not including itself as an End UE) in the out-going UE-to-UE Relay Discovery Announcement message. A U2U Relay may receive UE-to-UE Relay Discovery Announcement messages from other U2U Relays. If the U2U Relay is also an End UE, the U2U Relay (i.e. a hybrid UE) may process the direct discovery set(s) in the received UE-to-UE Relay Discovery Announcement message and store/update the route to each discovered End UE in a Direct Discovery Routing Table based on the corresponding previous hops Routing Information in the received UE-to-UE Relay Discovery Announcement message. After setting up the Direct Discovery Routing Table, the hybrid UE may not include the received previous hops Routing Information in the previous hops Routing Information of the outgoing UE-to-UE Relay Discovery Announcement message. The Monitoring End UE may process the direct discovery set(s) in the received UE-to-UE Relay Discovery Announcement message and store/update the route to each discovered End UE in a Direct Discovery Routing Table.

With regard to FIG. 2, for UE1 (Announced End UE), the User Info ID of UE1 represents the End UE User Info ID of UE1.

For Relay1 (U2U Relay UE), the User Info ID of Relay1 represents the U2U Relay User Info ID of Relay1. Relay1 may discover End UEs (here, UE1) in proximity and obtain direct discovery sets of End UEs in proximity per RSC. Relay1 may send a UE-to-UE Relay Discovery Announcement message, which may include one or more of the following: a list of direct discovery sets and a list of Source Layer-2 IDs of End UEs, a list of previous hops Routing Information for each End UE (here, User Info ID of Relay1 for End UE1), a list of hop counts from each End UE in the list of End UEs (here, hop count=1 for the End UE1), a RSC, and others.

For Relay2e (End UE serving as U2U Relay-hybrid UE), the User Info ID of Relay2e represents the End UE User Info ID of Relay2e. The User Info ID of Relay2 represents the U2U Relay User Info ID of Relay2e. Relay2e may discovers End UEs in proximity and obtain direct discovery sets of End UEs in proximity per RSC. Relay2e may receive a UE-to-UE Relay Discovery Announcement message from Relay1. Relay2e may process the direct discovery set(s) in the received UE-to-UE Relay Discovery Announcement message and store the route to each End UE in a Direct Discovery Routing Table. Relay2e may sends a UE-to-UE Relay Discovery Announcement message, which may include one or more of the following: a list of direct discovery sets and list of Source Layer-2 IDs of End UEs (here, Relay2e also announces itself as an End UE with User Info ID of Relay2e), a list of previous hops Routing Information for each End UE (here, User Info ID of Relay2 for End UE1, and Null for Relay2e announced as an End UE), a list of hop counts from each End UE in the list of End UEs (here, hop count=2 for End UE1, and hop count=0 for Relay2e announced as an End UE), RSC, and others.

For Relay3 (U2U Relay UE), the User Info ID of Relay3 represents the U2U Relay User Info ID of Relay3. Relay3 may discover End UEs in proximity and obtain direct discovery sets of End UEs in proximity per RSC. Relay3 may receive a UE-to-UE Relay Discovery Announcement message from Relay2e. Relay3 may send a UE-to-UE Relay Discovery Announcement message, which may include one or more of the following: a list of direct discovery sets and a list of Source Layer-2 IDs of End UEs, a list of previous hops Routing Information for each End UE (here, (User Info ID of Relay2, User Info ID of Relay3) for End UE1, and User Info ID of Relay3 for Relay2e announced as an End UE), a list of hop counts from each End UE in the list of End UEs (here, hop count=3 for End UE1, and hop count=1 for Relay2e announced as an End UE), RSC, and others.

For UE2 (Monitoring End UE) the User Info ID of UE2 represents the End UE User Info ID of UE2. UE2 may receive a UE-to-UE Relay Discovery Announcement message from Relay3. UE2 may process the direct discovery set(s) in the received UE-to-UE Relay Discovery Announcement message and store the route to each End UE in a Direct Discovery Routing Table.

In a general multihop/mesh configuration, any End UE provisioned with direct discovery security materials, including an End UE serving as a U2U Relay, may extract the direct discovery sets and obtain the End UE User Info IDs of other End UEs, and hence may set up a Direct Discovery Routing Table with an entry to each of other End UEs the End UE has discovered to facilitate a link establishment procedure. On the other hand, the direct discovery sets in the UE-to-UE Relay Discovery Announcement messages are transparent to U2U Relays not provisioned with direct discovery security materials. To facilitate routing, a route entry in the Direct Discovery Routing Table may include Routing Information (in terms of U2U Relay User Info IDs along the discovered path) to the next End UE (either an intermediate End UE serving as a U2U Relay or the Destination End UE itself) in order to reach the Destination End UE. Routing Information between End UEs may be accumulated hop by hop and recorded in the UE-to-UE Relay Discovery Announcement messages.

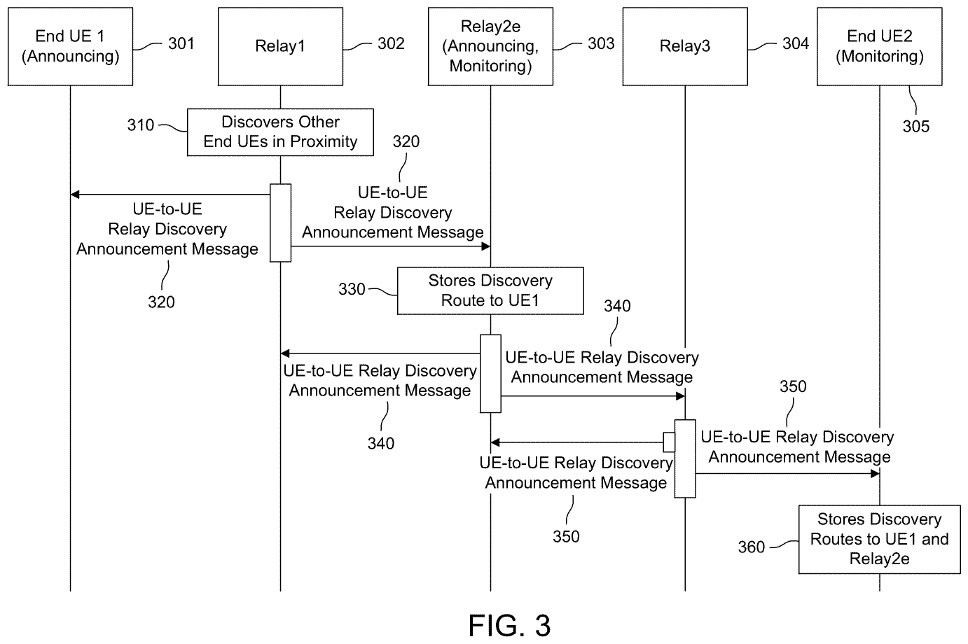

FIG. 3 shows an example of a heterogeneous multihop UE-to-UE Relay Discovery (Model A) procedure.

End UE1 (announced End UE) 301, End UE2 (monitoring End UE) 305, Relay1 302, Relay2e 303, and Relay3 304 may be provisioned with the discovery security materials associated with the authorized RSC.

End UE1, End UE2 and Relay2e (a candidate End UE serving as a U2U Relay) may be provisioned with the discovery security materials associated with a ProSe Direct Discovery service for Restricted ProSe Direct Discovery (to be abbreviated as direct discovery security materials).

Relay2e may be authorized and configured as a hybrid node (e.g. End UE serving as a U2U Relay). For example, Relay2e may send an indication of its capability to support a hybrid mode. The Relay2e may send the indication when registering with the network, for example. Relay2e may receive configuration information with an indication (e.g. flag or any type of indication) to operate (e.g. authorization) as a hybrid node (e.g. an End UE to also serve as a UE-to-UE relay). For Relay2e serving as a U2U Relay, the User Info ID of Relay2 is used as the U2U Relay User Info ID and is not protected with the direct discovery security materials. For Relay2e serving as an End UE, the User Info ID of Relay2e is used as the End UE User Info ID and is protected with the direct discovery security materials.

Relay1 may have discovered other End UEs in proximity 310. For example Relay1 may have discovered other End UEs in proximity via previous UE-to-UE Relay Discovery or UE-to-UE Relay Communication procedures. Relay1 may obtain the direct discovery sets of other End UEs in proximity per RSC. The End UE may protect the direct discovery set using direct discovery security materials. The protected direct discovery set includes the End UE User Info ID.

Relay1 may send a UE-to-UE Relay Discovery Announcement message 320. Relay1 may only announce direct discovery sets and Layer-2 IDs of other End UEs in proximity that did not include an indication to prohibit announcement (e.g. Announce Prohibited Indication) when they were previously discovered. The UE-to-UE Relay Discovery Announcement message sent by Relay1 may include one or more of the following: a list of direct discovery sets and a list of Source Layer-2 IDs of End UEs, a list of previous hops Routing Information for each End UE (here, User Info ID of Relay1 for End UE1), a list of hop counts from each End UE in the list of End UEs (here, hop count=1 for End UE1), RSC, and others. The list of direct discovery sets of End UEs may include direct discovery sets of the neighbor End UEs in conjunction with the non-overlapping direct discovery sets of End UEs received from neighboring U2U Relays or End UEs acting as U2U Relays, if available. A list of Source Layer-2 IDs of End UEs may include the Source Layer-2 ID of each End UE in the list of direct discovery sets of End UEs. If the processing U2U Relay does not maintain a Direct Discovery Routing Table (here, Relay1), for each direct discovery set received from an End UE, the corresponding previous hops Routing Information=User Info ID of sender U2U Relay (here, User Info ID of Relay1) of the outgoing UE-to-UE Relay Discovery Announcement message. Before sending the UE-to-UE Relay Discovery Announcement message, Relay1 may protect the message using the discovery security materials associated with the RSC.

Relay2e may receive the UE-to-UE Relay Discovery Announcement message from Relay1 320. Relay2e may process the received message using the discovery security materials associated with the RSC. If RSC matches the authorized information, Relay2e may process the direct discovery set(s) using direct discovery security materials. If the route to an End UE in the received direct discovery set(s) does not exist in the Direct Discovery Routing Table, Relay2e may store the route to that End UE 330. Relay2e's Direct Discovery Routing Table (per RSC) entry to End UE1 may include one or more of the following information: Destination End UE (i.e. User Info ID of End UE1); Destination End UE Layer-2 ID, which may be set to the Source Layer-2 ID associated with End UE1 in the received UE-to-UE Relay Discovery Announcement message; number of hops to Destination End UE, which may be the received hop count value associated with End UE1 increased by 1 (here, 2); next hops Routing Information, which may be set to the received previous hops Routing Information associated with End UE1 (here, User Info ID of Relay1) in the received UE-to-UE Relay Discovery Announcement message in reverse order.

If a route to an End UE already exists, Relay2e may update the route to the End UE based on various criteria, for example, minimum hop count value or channel quality of the received message.

When the same direct discovery sets are received from different U2U Relays or End UEs acting as U2U Relays, or directly from the End UE, Relay2e may select a route to be put in the Direct Discovery Routing Table for the route entry to the End UE based on various criteria, for example, minimum hop count value or channel quality of the received message.

Relay2e may send a UE-to-UE Relay Discovery Announcement message 340. Relay2e shall only announce direct discovery sets and Layer-2 IDs of other End UEs in proximity that did not include an Announce Prohibited Indication when they were previously discovered. The UE-to-UE Relay Discovery Announcement message sent by Relay2e may include one or more of the following: a list of direct discovery sets and list of Source Layer-2 IDs of End UEs (here, Relay2e may also announce itself as an End UE with User Info ID of Relay2e), a list of previous hops Routing Information for each End UE (here, User Info ID of Relay2 for the End UE1, and Null for Relay2e announced as an End UE), a list of hop counts from each End UE in the list of End UEs (here, hop count=2 for End UE1, and hop count=0 for Relay2e announced as an End UE), RSC, and others. A list of direct discovery sets of End UEs may include direct discovery sets of the neighbor End UEs in conjunction with the non-overlapping direct discovery sets of End UEs received from neighboring U2U Relays (here, Relay1) or End UEs acting as U2U Relays, and direct discovery set of Relay2e announced as End UE. A list of Source Layer-2 IDs of End UEs may include the Source Layer-2 ID of each of End UE in the list of direct discovery sets of End UEs. If the processing U2U Relay is also an End UE (here, Relay2e), for direct discovery set of the processing U2U Relay announced as End UE (here, Relay2e), previous hops Routing Information=Null. For each direct discovery set of all other End UEs, previous hops Routing Information=U2U Relay User Info ID of the processing U2U Relay (here, User Info ID of Relay2). Before sending the UE-to-UE Relay Discovery Announcement message, Relay2e may protect the message using the discovery security materials associated with the RSC.

Relay3 may receive the UE-to-UE Relay Discovery Announcement message from Relay2e 340. Relay3 may process the received message using the discovery security materials associated with the RSC. If RSC matches the authorized information, Relay3 may send a UE-to-UE Relay Discovery Announcement message 350.

Relay3 shall only announce direct discovery sets and Layer-2 IDs of other End UEs in proximity that did not include an Announce Prohibited Indication when they were previously discovered.

The UE-to-UE Relay Discovery Announcement message sent by Relay3 may include one or more of the following: a list of direct discovery sets and list of Source Layer-2 IDs of End UEs, a list of previous hops Routing Information for each End UE (here, (User Info ID of Relay2, User Info ID of Relay3) for End UE1 and User Info ID of Relay3 for Relay2e announced as an End UE), a list of hop counts from each End UE in the list of End UEs (here, hop count=3 for End UE1, and hop count=1 for Relay2e announced as an End UE), RSC, and others.

A list of direct discovery sets of End UEs may include direct discovery sets of the neighbor End UEs in conjunction with the non-overlapping direct discovery sets of End UEs received from neighboring U2U Relays or End UEs acting as U2U Relays (here, Relay2e). A list of Source Layer-2 IDs of End UEs may include the Source Layer-2 ID of each End UE in the list of direct discovery sets of End UEs.

If the processing U2U Relay is not an End UE (here, Relay3), for each direct discovery set of an End UE received from the End UE or another End UE acting as a U2U Relay (here, Relay2e), the corresponding previous hops Routing Information=User Info ID of sender U2U Relay (here, User Info ID of Relay3) of the outgoing UE-to-UE Relay Discovery Announcement message. For each direct discovery set of an End UE received from a U2U Relay that is not an End UE, append the sender U2U Relay (here, Relay3) of the outgoing UE-to-UE Relay Discovery Announcement message to the end of the corresponding previous hops Routing Information.

When the same direct discovery sets are received from different U2U Relays or End UEs acting as U2U Relays, or directly from the associated End UE, Relay3 may determine the previous hops Routing Information in the UE-to-UE Relay Discovery Announcement message to be sent to next hop based on various criteria, for example, minimum hop count value, or channel quality of the received message.

Before sending the UE-to-UE Relay Discovery Announcement message, Relay3 may protect the message using the discovery security materials associated with the RSC.

UE2 (monitoring End UE) may receive the UE-to-UE Relay Discovery Announcement message from Relay3 350. UE2 may process the received message using the discovery security materials associated with the RSC. If RSC matches the authorized information, UE2 processes the direct discovery set(s) using direct discovery security materials.

If the route to an End UE in the received direct discovery set(s) does not exist in the Direct Discovery Routing Table, UE2 may store the selected route to the corresponding End UE (per direct discovery set) in a Direct Discovery Routing Table.

UE2's Direct Discovery Routing Table (per RSC) entry to End UE1 may include one or more of the following information: Destination End UE, which may be the User Info ID of End UE1; Destination End UE Layer-2 ID, which may be set to the Source Layer-2 ID associated with the End UE1 in the received UE-to-UE Relay Discovery Announcement message; number of hops to Destination End UE, where the received hop count value associated with End UE1 increased by 1 (here, 4); next hops Routing Information, which may be set to the received previous hops Routing Information associated with End UE1 (here, User Info ID of Relay3, User Info ID of Relay2) in the received UE-to-UE Relay Discovery Announcement message in reverse order.

UE2's Direct Discovery Routing Table (per RSC) entry to Relay2e may include one or more of the following information: Destination End UE, which may be the User Info ID of Relay2e; Destination End UE Layer-2 ID, which may be set to the Source Layer-2 ID associated with Relay2e in the received UE-to-UE Relay Discovery Announcement message; number of hops to Destination End UE, where the received hop count value associated with Relay2e increased by 1 (here, 2); next hops Routing Information, which may be set to the received previous hops Routing Information associated with Relay2e (here, User Info ID of Relay3) in the received UE-to-UE Relay Discovery Announcement message in reverse order.

If the route to an End UE already exists, the monitoring End UE (UE2) may update the route to the corresponding End UE based on various criteria, for example, minimum hop count value or channel quality of the received message.

When the same direct discovery sets are received from different U2U Relays or End UEs acting as U2U Relays, or directly from the associated End UE, UE2 may select a route to be put in the Direct Discovery Routing Table for the route entry to the End UE based on various criteria, for example, minimum hop count value or channel quality of the received message.

To cope with UE mobility in a UE-to-UE Relay mesh network, each route entry in the Direct Discovery Routing Table may time-out after a preconfigured validity time period. Routes may be updated when receiving new U2U Relay Discovery Announcement messages.

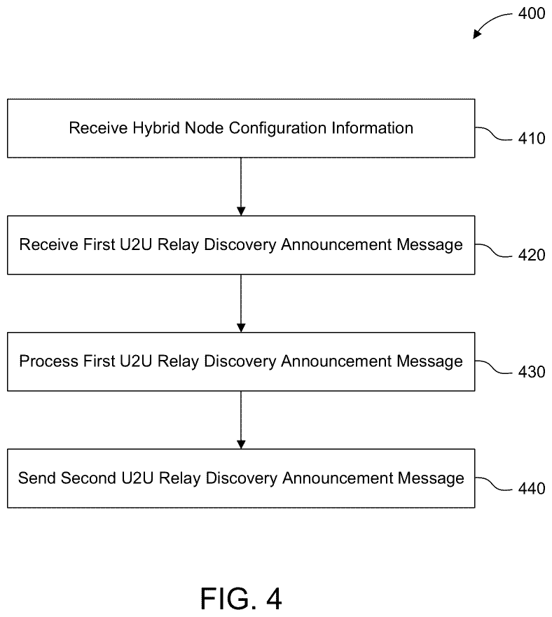

FIG. 4 shows an example method 400 for heterogeneous multihop UE-to-UE (U2U) relay discovery for use by a hybrid node UE (i.e. an end UE which also serves as a U2U relay), for example Relay2e in FIG. 2. A UE may receive a configuration message 410. The configuration message may comprise hybrid node configuration information. The configuration message may comprise an indication (e.g. flag) for the UE to also serve as a U2U relay. The configuration message may comprise configuration information for the UE to serve as a U2U relay. The end UE, which also serves as a U2U relay, may be referred to as a hybrid node or a hybrid UE. The UE may send capability information to the network indicating its capability to act as a hybrid UE. The UE may send the capability information, for example, when registering with the network. The UE may receive the (hybrid node) configuration message in response to or based on the sending the capability information.

The hybrid UE may receive a first message 420. The first message may be a U2U relay discovery announcement message. The hybrid UE may receive the first message from a first U2U relay, for example Relay1 in FIG. 2. The first message may comprise one or more direct discovery sets. A direct discovery set may be protected using discovery security materials associated with a ProSe Direct Discovery service (to be abbreviated as direct discovery security materials). The direct discovery sets may include end UE user information (info) identification (ID)s of one or more end UE(s), along with other parameters. The direct discovery sets may comprise direct discovery sets of the neighbor end UEs in conjunction with the non-overlapping direct discovery sets of end UEs received from neighboring U2U relays or end UEs acting as U2U relays. The first message may comprise a list of source layer-2 IDs of end UEs. The list of source layer-2 IDs may include the source layer-2 ID of each end UE in the list of direct discovery sets of end UEs. The first message may comprise a previous hops routing information. Previous hops routing information may comprise the sequence of user info ID(s) of U2U relay(s) associated with an announcing end UE accumulated hop-by-hop from the closest previous end UE (which may be either a hybrid UE or the announcing end UE), when propagating the U2U relay discovery announcement message. The first message may comprise a list of hop counts from each end UE in the list of end UEs. The first message may be protected using discovery security material associated with the RSC.

The hybrid UE may process the first message 430. The hybrid UE may process the direct discovery set(s) in the received first message. The hybrid UE may processes the received message using the discovery security materials associated with the RSC. If the RSC matches the authorized information, the hybrid UE may process the direct discovery set(s) using direct discovery security materials. A direct discovery routing table may be set up during a U2U relay discovery procedure. Only UEs provisioned with direct discovery security materials may construct a direct discovery routing table. The hybrid UE may add/store and/or update the route to each discovered end UE in the direct discovery routing table based on the corresponding previous hops routing information in the received first message. If the route to an end UE in the received direct discovery set(s) does not exist in the direct discovery routing table, the hybrid UE may add/store the route to that end UE. A route entry in the direct discovery routing table may include next hops routing information, in terms of U2U Relay User Info IDs along the discovered path to the next end UE (either an intermediate hybrid UE or the destination end UE itself) in order to reach the destination end UE. Routing information between one end/hybrid UE to another end/hybrid UE may be accumulated hop by hop and recorded in the U2U relay discovery announcement messages. The direct discovery routing table (per RSC) entry to an end UE1 may include the destination end UE, for example, user info ID of the end UE. The direct discovery routing table (per RSC) entry to an end UE1 may include a destination end UE layer-2 ID, for example, which may be set to the source layer-2 ID associated with end UE1 in the received U2U relay discovery announcement message. The direct discovery routing table (per RSC) entry to an end UE1 may include a number of hops to a destination end UE, for example a received hop count value associated with end UE1 increased by 1. The direct discovery routing table (per RSC) entry to an end UE1 may include a next hops routing information, for example, set to the received previous hops routing information associated with end UE1 in the received U2U relay discovery announcement message in reverse order. The hybrid UE may then clear the received previous hops routing information. If a route to an end UE already exists, the hybrid UE may update the route to the end UE based on various criteria, for example, a minimum hop count value or channel quality of the received message. When the same direct discovery sets are received from different U2U relays or end UEs acting as U2U relays, or directly from the end UE, the hybrid UE may select a route to be put in the direct discovery routing table for the route entry to the end UE based on various criteria, for example, a minimum hop count value or channel quality of the received message. The hybrid UE may then clear the received previous hops routing information.

The hybrid UE may send a second message 440. The second message may be a U2U relay discovery announcement message. The hybrid UE may announce itself in the second message. The hybrid UE may include its end UE user info ID in the direct discovery set in the second message. The hybrid UE may discover end UEs in proximity. The hybrid UE may obtain direct discovery sets of end UEs in proximity per relay service code (RSC). The list of direct discovery sets of end UEs may include direct discovery sets of the neighbor end UEs in conjunction with the non-overlapping direct discovery sets of end UEs received from neighboring U2U relays or end UEs acting as U2U relays, and a direct discovery set of the hybrid UE announced as an end UE. The hybrid UE may announce the end UEs in proximity. The hybrid UE may include a list of direct discovery sets and a list of Source Layer-2 IDs of end UEs. The list of source layer-2 IDs of end UEs may include the source layer-2 IDs of each of end UE in the list of direct discovery sets of end UEs. The hybrid UE may announce additional end UEs received from other relay UEs. The hybrid UE may include a list of previous hops routing information for each end UE. The hybrid UE may include its U2U relay user info ID in the previous hops routing information, for each received end UE, in the second message. The hybrid UE may include a list of hop counts from each end UE in the list of end UEs. The hybrid UE may include the RSC. Before sending the second message, the hybrid UE may protect the message using the discovery security materials associated with the RSC.

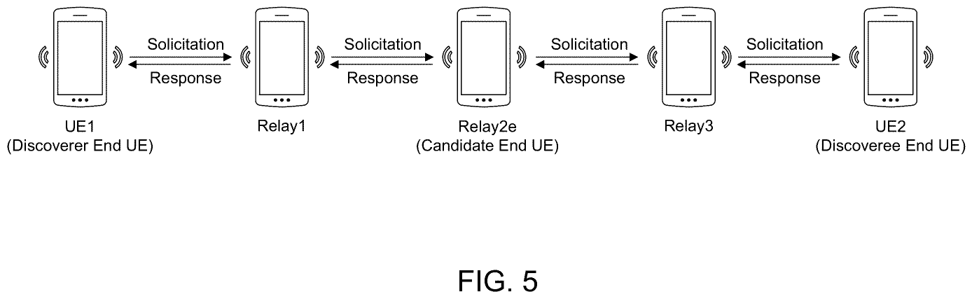

FIG. 5 shows an example configuration for heterogeneous multihop UE-to-UE relay discovery (Model B).

Relay2e may be authorized and configured as a hybrid node (i.e. End UE serving as a U2U Relay).

A Discoverer End UE (UE1) may send a UE-to-UE Relay Discovery Solicitation message.

A U2U Relay may receive the UE-to-UE Relay Discovery Solicitation message and may send a UE-to-UE Relay Discovery Solicitation message until a maximum hop count is reached.

If the U2U Relay is also an End UE, the U2U Relay may process the direct discovery set in the received UE-to-UE Relay Discovery Solicitation message and may store/update the route to the discoverer End UE in a Direct Discovery Routing Table based on the previous hops Routing Information in the received UE-to-UE Relay Discovery Solicitation message. The U2U Relay may clear the received previous hops Routing Information.

The U2U Relay (End UE or not) may include its U2U Relay User Info ID in the previous hops Routing Information in the out-going UE-to-UE Relay Discovery Solicitation message.

A Discoveree End UE (UE2) may process the direct discovery set in the received UE-to-UE Relay Discovery Solicitation message and may store/update the route to the discoverer End UE in a Direct Discovery Routing Table.

The Discoveree End UE may send a UE-to-UE Relay Discovery Response message based on the next hops Routing Information with a destination of the discoverer End UE in its Direct Discovery Routing Table.

A U2U Relay may receive the UE-to-UE Relay Discovery Response message and may send a UE-to-UE Relay Discovery Response message to the next hop with a destination of the discoverer End UE.

If the U2U Relay is also an End UE, the U2U Relay may process the direct discovery set in the received UE-to-UE Relay Discovery Response message and may store/update the route to the discoveree End UE in a Direct Discovery Routing Table based on the previous hops Routing Information in the received UE-to-UE Relay Discovery Response message. The U2U Relay may clear the received previous hops Routing Information.

The U2U Relay (intermediate End UE or not) may include its U2U Relay User Info ID in the previous hops Routing Information in the out-going UE-to-UE Relay Discovery Response message.

If the U2U Relay is an intermediate End UE, the U2U Relay may send the UE-to-UE Relay Discovery Response message based on the next hops Routing Information with a destination of the discoverer End UE in its Direct Discovery Routing Table.

If the U2U Relay is not an End UE, the U2U Relay may send the UE-to-UE Relay Discovery Response message based on the next hops Routing Information included in the received UE-to-UE Relay Discovery Response messages.

The Discoverer End UE may process the direct discovery set in the received UE-to-UE Relay Discovery Response message and may store/update the route to the discoveree End UE in a Direct Discovery Routing Table.

Referring to FIG. 5, for UE1 (Discoverer End UE), the User Info ID of UE1 may represent the End UE User Info ID of UE1. UE1 may send a UE-to-UE Relay Discovery Solicitation message, which may include one or more of: direct discovery set of UE1 and UE2, a hop count from UE1 (here, 0), a maximum hops allowed, a RSC, and others. UE1 may receive a UE-to-UE Relay Discovery Response message from Relay1. UE1 may process the direct discovery sets in the received UE-to-UE Relay Discovery Response message and may store the route to UE2 in a Direct Discovery Routing Table.

For Relay1, (U2U Relay UE), the User Info ID of Relay1 may represents the U2U Relay User Info ID of Relay1. Relay1 may receive the UE-to-UE Relay Discovery Solicitation message from UE1. Relay1 may send the UE-to-UE Relay Discovery Solicitation message, which may include one or more of: direct discovery set of UE1 and UE2, a Source Layer-2 ID of UE1, previous hops Routing Information (here, User Info ID of Relay1), hop count from UE1 (here, 1), a maximum hops allowed, RSC, and others. Relay1 may receive a UE-to-UE Relay Discovery Response message from Relay2e. Relay1 may send a UE-to-UE Relay Discovery Response message to UE1, which may include one or more of: direct discovery set of UE1 and UE2, a Source Layer-2 ID of the UE2, previous hops Routing Information (here, User Info ID of Relay2, User Info ID of Relay1), hop count from UE2 (here, 3), RSC and others, using UE1's Source Layer-2 ID as the Destination Layer-2 ID.

For Relay2e (End UE serving as U2U Relay-hybrid node), the User Info ID of Relay2e may represent the End UE User Info ID of Relay2e and the User Info ID of Relay2 may represent the U2U Relay User Info ID of Relay2e. Relay2e may receive the UE-to-UE Relay Discovery Solicitation message from Relay1. Relay2e may process the direct discovery set in the received UE-to-UE Relay Discovery Solicitation message and may store the route to UE1 in a Direct Discovery Routing Table. Relay2e may reply to UE1 with a UE-to-UE Relay Discovery Response message if the Direct Discovery Routing Table already has a route to UE2, via Relay1. Relay2e may send UE-to-UE Relay Discovery Gratuitous Response message to UE2 to allow the setup of a reverse route from UE2 to UE1. Relay2e may send a UE-to-UE Relay Discovery Solicitation message, which may include one or more of: direct discovery set of UE1 and UE2, Source Layer-2 ID of UE1, previous hops Routing Information (here, User Info ID of Relay2), hop count from UE1 (here, 2), a maximum hops allowed, RSC, and others. Relay2e may receive a UE-to-UE Relay Discovery Response message from Relay3. Relay2e may process the direct discovery set in the received UE-to-UE Relay Discovery Response message and may store the route to UE2 in a Direct Discovery Routing Table. Relay2e may send the UE-to-UE Relay Discovery Response message to Relay1, which may include one or more of: direct discovery set of UE1 and UE2, a Source Layer-2 ID of the UE1, a Source Layer-2 ID of UE2, previous hops Routing Information (here, User Info ID of Relay2), next hops Routing Information (here, User Info ID of Relay1), hop count from UE2 (here, 2), a RSC, and others, based on the next hops Routing Information in its Direct Discovery Routing Table.

For Relay3 (U2U Relay UE), the User Info ID of Relay3 may represent the U2U Relay User Info ID of Relay3. Relay3 may receive the UE-to-UE Relay Discovery Solicitation message from Relay2e. Relay3 may send a UE-to-UE Relay Discovery Solicitation message, which may include one or more of: direct discovery set of UE1 and UE2, a Source Layer-2 ID of UE1, previous hops Routing Information (here, User Info ID of Relay2, User Info ID of Relay3), hop count from UE1 (here, 3), a maximum hops allowed, RSC, and others. Relay3 may receive a UE-to-UE Relay Discovery Response message from UE2. Relay3 may send the UE-to-UE Relay Discovery Response message to Relay2e, which may include one or more of: direct discovery set of UE1 and UE2, a Source Layer-2 ID of UE1, a Source Layer-2 ID of UE2, previous hops Routing Information (here, User Info ID of Relay3), next hops Routing Information (here, User Info ID of Relay2), hop count from UE2 (here, 1), a RSC and others.

For UE2 (Discoveree End UE), the User Info ID of UE2 may represent the End UE User Info ID of UE2. UE2 may receive the UE-to-UE Relay Discovery Solicitation message from Relay3. UE2 may process the direct discovery sets in the received UE-to-UE Relay Discovery Solicitation message and may store the route to UE1 in a Direct Discovery Routing Table. UE2 may send the UE-to-UE Relay Discovery Response message to Relay3, which may include one or more of: direct discovery set of UE1 and UE2, a Source Layer-2 ID of UE1, next hops Routing Information (here, User Info ID of Relay3, User Info ID of Relay2), hop count from UE2 (here, 0), RSC, and others, based on the next hops Routing Information in its Direct Discovery Routing Table.

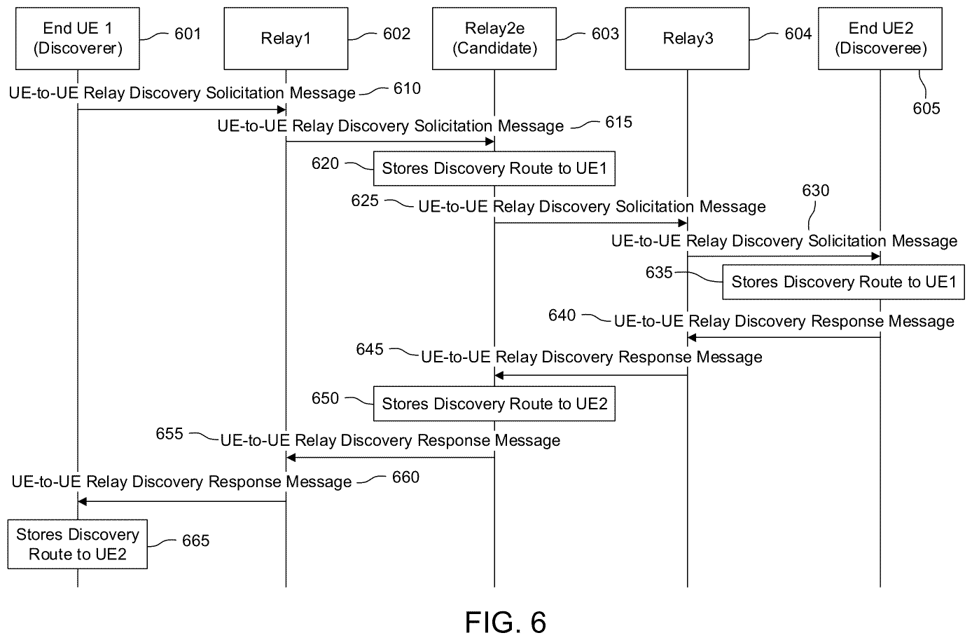

FIG. 6 shows an example of a heterogeneous multihop UE-to-UE Relay Discovery (Model B) procedure.

In a general multihop/mesh configuration, any End UE provisioned with direct discovery security materials, including an End UE serving as a U2U Relay, may extract the direct discovery sets and may obtain the End UE User Info IDs of other End UEs, and hence may set up a Direct Discovery Routing Table with an entry to each of other End UEs the End UE has discovered to facilitate a link establishment procedure. On the other hand, the direct discovery sets in the UE-to-UE Relay Discovery Solicitation/Response messages are transparent to U2U Relays not provisioned with direct discovery security materials. To facilitate routing, a route entry in the Direct Discovery Routing Table may include Routing Information, in terms of U2U Relay User Info IDs along the discovered path, to the next End UE, either an intermediate End UE serving as a U2U Relay (i.e. a hybrid UE) or the Destination End UE itself, in order to reach the Destination End UE. Routing Information between End UEs may be accumulated hop by hop and recorded in the UE-to-UE Relay Discovery Solicitation/Response messages.

UE1 601, UE2 605, Relay1 602, Relay2e 603, and Relay3 604 may be provisioned with the discovery security materials associated with the authorized RSC.

UE1 601, UE2 605, and Relay2e 603 (a candidate End UE serving as a U2U Relay) may be provisioned with the discovery security materials associated with a ProSe Direct Discovery service for Restricted ProSe Direct Discovery (to be abbreviated as direct discovery security materials).

Relay2e 603 may be authorized and configured as a hybrid node (End UE serving as a U2U Relay). For Relay2e serving as a U2U Relay, the User Info ID of Relay2 is used as the U2U Relay User Info ID and is not protected with the direct discovery security materials. For Relay2e serving as an End UE, the User Info ID of Relay2e is used as the End UE User Info ID and is protected with the direct discovery security materials.

UE1 (discoverer End UE) 601 may send a UE-to-UE Relay Discovery Solicitation message 610. UE1 may protect a direct discovery set using direct discovery security materials. The protected direct discovery set may include the User Info ID of UE1 (discoverer End UE) and User Info ID of UE2 (discoveree End UE). UE1 may include the protected direct discovery set in the UE-to-UE Relay Discovery Solicitation message and may protect the message using the discovery security materials associated with the Relay Service Code (RSC). The UE-to-UE Relay Discovery Solicitation message sent by UE1 may include one or more of: direct discovery set of discoverer and discoveree End UEs (here, UE1 and UE2), hop count from the discoverer End UE (here, hop count=0), a maximum number of hops allowed, RSC, and others.

Relay1 602 may receive the UE-to-UE Relay Discovery Solicitation message from UE1 615. Relay1 may process the received message using the discovery security materials associated with the RSC. If the RSC matches the authorized information, Relay1 may send a UE-to-UE Relay Discovery Solicitation message. The UE-to-UE Relay Discovery Solicitation message sent by Relay1 may include one or more of: direct discovery set of discoverer and discoveree End UEs (here, UE1 and UE2), Source Layer-2 ID of the discoverer End UE (here, UE1), previous hops Routing Information (here, User Info ID of Relay1), hop count from the discoverer End UE (hop count in the received UE-to-UE Relay Discovery Solicitation message plus 1; here, hop count=1), a maximum number of hops allowed, RSC, and others. The Source Layer-2 ID of the discoverer End UE may be determined based on the Source Layer-2 ID of the received UE-to-UE Relay Discovery Solicitation message and may be used by Relay1 to send the UE-to-UE Relay Discovery Response message to the discoverer End UE. The Source Layer-2 ID of the discoverer End UE may be included in the UE-to-UE Relay Discovery Solicitation message such that Relay1 may identify the received UE-to-UE Relay Discovery Response message based on the Source Layer-2 ID of the discoverer End UE for deciding which discoverer End UE to send. Relay1 may add/include/append itself to the end of previous hops Routing Information (i.e., the last U2U Relay in the previous hops Routing Information is the sender U2U Relay). The UE-to-UE Relay Discovery Solicitation message may be protected using the security materials associated with the RSC.

Relay2e 603 may receive the UE-to-UE Relay Discovery Solicitation message from Relay1 615. Relay2e may process the received message using the discovery security materials associated with the RSC. If the RSC matches the authorized information, Relay2e (which is also a candidate End UE) may process the direct discovery set using direct discovery security materials. If Discoveree End UE's User Info ID in the direct discovery set does not match the Relay2e's End UE User Info ID (here, User Info ID of Relay2e), Relay2e may store the route to UE1 in a Direct Discovery Routing Table 620. If Discoveree End UE's User Info ID in the direct discovery set were to match the End UE User Info ID of Relay2e, Relay2e would be the target Discoveree UE. Relay2e's Direct Discovery Routing Table (with matching RSC) entry to UE1 (discoverer End UE) may include one or more of the following information: Destination End UE, which may be the User Info ID of UE1; Destination End UE Layer-2 ID, which may be the Source Layer-2 ID of UE1; number of hops to Destination End UE, where the received hop count value increased by 1 (here, 2); and next hops Routing Information, where the User Info ID of Relay1 (set to the previous hops Routing Information in the received UE-to-UE Relay Discovery Solicitation message in reverse order).

When the same direct discovery sets are received from different U2U Relays or candidate End UEs acting as U2U Relays, or directly from the discoverer End UE, Relay2e may select a route to be put in the Direct Discovery Routing Table for the route entry to the discoverer End UE (here, UE1) based on various criteria, for example, minimum hop count value or channel quality of the received UE-to-UE Relay Discovery Solicitation message. Relay2e may determine the previous hops Routing Information in the UE-to-UE Relay Discovery Solicitation message to be sent to next hop based on the selected route.

If the Direct Discovery Routing Table does not have a route to UE2 (discoveree End UE), Relay2e may send a UE-to-UE Relay Discovery Solicitation message 625. The UE-to-UE Relay Discovery Solicitation message sent by Relay2e may include one or more of: direct discovery set of discoverer and discoveree End UEs (here, UE1 and UE2), Source Layer-2 ID of discoverer End UE (here, UE1), previous hops Routing Information (here, User Info ID of Relay2), hop count from the discoverer End UE (hop count in the received Discovery Solicitation message plus 1; here, hop count=2), maximum number of hops allowed, RSC, and others. When the received hop count value increased by 1 exceeds a maximum number of hops allowed, the received UE-to-UE Relay Discovery Solicitation message may be discarded. The direct discovery set of discoverer and discoveree End UEs may be protected using direct discovery security materials. The UE-to-UE Relay Discovery Solicitation message may be protected using the security materials associated with the RSC.

If the Direct Discovery Routing Table of Relay2e already has a route to UE2 (discoveree End UE), Relay2e may reply to UE1 (discoverer End UE) with a UE-to-UE Relay Discovery Response message. The UE-to-UE Relay Discovery Response message sent by Relay2e may include one or more of: direct discovery set of discoverer and discoveree End UEs (here, UE1 and UE2), Source Layer-2 ID of the discoverer End UE (here, UE1), Source Layer-2 ID of the discoveree End UE (here, UE2, as stored in the Direct Discovery Routing Table entry to the discoveree End UE and to be used as the Destination Layer-2 ID of target End UE in the Direct Communication Request message during link establishment), previous hops Routing Information (here, User Info ID of Relay2), next hops Routing Information (here, User Info ID of Relay1, based on the information in the Direct Discovery Routing Table entry to the discoverer End UE), hop count from the discoveree End UE (hop count stored in the Direct Discovery Routing Table entry to UE1; here, hop count=2), RSC, and others.

Relay2e's Direct Discovery Routing Table (with matching RSC) entry to UE2 (discoveree End UE) may include one or more of: Destination End UE, which may be the User Info ID of UE2; Destination End UE Layer-2 ID, which may be the Source Layer-2 ID of UE2; number of Hops to Destination End UE, here 2; next hops Routing Information, which may be the User Info ID of Relay3.

If the hop count value to UE2 in the Direct Discovery Routing Table plus the received hop count value increased by 1 exceeds the maximum number of hops allowed received in the UE-to-UE Relay Discovery Solicitation message, Relay2e may not send the UE-to-UE Relay Discovery Response message to UE1.

If the Direct Discovery Routing Table of Relay2e already has a route to UE2 (discoveree End UE), Relay2e may also send (e.g., via unicast) a UE-to-UE Relay Discovery Gratuitous Response message to UE2 to allow the setup of a reverse route from UE2 to UE1 (discoverer End UE).

The UE-to-UE Relay Discovery Gratuitous Response message sent by Relay2e may include one or more of: direct discovery set of discoverer and discoveree End UEs (here, UE1 and UE2), Source Layer-2 ID of the discoveree End UE (here, UE2, as stored in the Direct Discovery Routing Table entry to the discoveree End UE and to be used as the Destination Layer-2 ID of target End UE by Relay3 to send the UE-to-UE Relay Discovery Gratuitous Response message to UE2), previous hops Routing Information (here, User Info ID of Relay2), next hops Routing Information (as stored in the Direct Discovery Routing Table entry to the discoveree End UE, here, User Info ID of Relay3), hop count from the discoverer End UE (hop count stored in the Direct Discovery Routing Table entry to UE1, here hop count=2), RSC, and others.

If the hop count value to UE2 in the Direct Discovery Routing Table plus the received hop count value increased by 1 exceeds the maximum number of hops allowed received in the UE-to-UE Relay Discovery Solicitation message, Relay2e may not send the UE-to-UE Relay Discovery Gratuitous Response message to UE2.

Relay3 604 may receive the UE-to-UE Relay Discovery Solicitation message from Relay2e 625. Relay3 may process the received message using the discovery security materials associated with the RSC. If the RSC matches the authorized information, Relay3 may send a UE-to-UE Relay Discovery Solicitation message 630.

The UE-to-UE Relay Discovery Solicitation message sent by Relay3 630 may include one or more of: direct discovery set of discoverer and discoveree End UEs (here, UE1 and UE2), Source Layer-2 ID of discoverer End UE (here, UE1), previous hops Routing Information (here, User Info ID of Relay2, User Info ID of Relay3), hop count from the discoverer End UE (hop count in the received Discovery Solicitation message plus 1, here, hop count=3), maximum number of hops allowed, RSC, and others. Relay3 may add/include/append itself to end of the previous hops Routing Information (i.e., the last U2U Relay in the previous hops Routing Information is the sender U2U Relay). When the same direct discovery sets are received from different U2U Relays or candidate End UEs acting as U2U Relays, or directly from the discoverer End UE, Relay3 may determine the previous hops Routing Information in the UE-to-UE Relay Discovery Solicitation message to be sent to next hop based on various criteria, for example, minimum hop count value or channel quality of the received UE-to-UE Relay Discovery Solicitation message. When the received hop count value increased by 1 exceeds a maximum number of hops allowed, the received UE-to-UE Relay Discovery Solicitation message may be discarded. The UE-to-UE Relay Discovery Solicitation message may be protected using the security materials associated with the RSC.

UE2 (discoveree End UE) 605 may receive the UE-to-UE Relay Discovery Solicitation message 630 from Relay3. UE2 may process the received UE-to-UE Relay Discovery Solicitation message using the discovery security materials associated with the RSC. If RSC matches the authorized information, UE2 processes the direct discovery set of discoverer and discoveree End UEs using direct discovery security materials.

When the received hop count value increased by 1 exceeds a maximum number of hops allowed, or when the channel quality of the received message is below a preconfigured threshold, the received UE-to-UE Relay Discovery Solicitation message may be discarded.

If UE2 (Discoveree End UE's) User Info ID in the direct discovery set matches UE2's User Info ID, UE2 may store the route to UE1 in a Direct Discovery Routing Table 635. UE2's Direct Discovery Routing Table (with matching RSC) entry to UE1 (discoverer End UE) may include one or more of the following information: Destination End UE, which may be the User Info ID of UE1; Destination End UE Layer-2 ID, which may be the Source Layer-2 ID of UE1; number of hops to Destination End UE, where the received hop count value is increased by 1 (here, 4); next hops Routing Information, which may be the User Info ID of Relay3, User Info ID of Relay2 (set to the previous hops Routing Information in the received UE-to-UE Relay Discovery Solicitation message in reverse order).

When the same direct discovery sets are received from different U2U Relays or candidate End UEs acting as U2U Relays, or directly from the discoverer End UE, UE2 may select a route to be put in the Direct Discovery Routing Table for the route entry to the discoverer End UE (here, UE1) based on various criteria, for example, a minimum hop count value or channel quality of received UE-to-UE Relay Discovery Solicitation message.

UE2 (Discoveree End UE) may send a UE-to-UE Relay Discovery Response message 640 to the first U2U Relay in the next hops Routing Information (here, Relay3) from the Direct Discovery Routing Table entry to UE1 (Discoverer End UE).

The UE-to-UE Relay Discovery Response message sent by UE2 may include one or more of: direct discovery set of discoverer and discoveree End UEs (here, UE1 and UE2), Source Layer-2 ID of discoverer End UE (here, UE1), next hops Routing Information (here, User Info ID of Relay3, User Info ID of Relay2), hop count from the discoveree End UE (here, hop count=0), RSC, and others.

The Source Layer-2 ID of the discoverer End UE may be determined based on the Destination End UE Layer-2 ID in UE2's Direct Discovery Routing Table and may be used by Relay1 to send the UE-to-UE Relay Discovery Response message to the discoverer End UE.

The direct discovery set of discoverer and discoveree End UEs may be protected using direct discovery security materials. The UE-to-UE Relay Discovery Response message may protected using the security materials associated with the RSC.

Relay3 may receive the UE-to-UE Relay Discovery Response message 640 from UE2 (discoveree End UE). Relay3 may process the received message using the discovery security materials associated with the RSC. If the RSC matches the authorized information, Relay3 may send a UE-to-UE Relay Discovery Response message 645 to Relay2e based on the next hops Routing Information in the received UE-to-UE Relay Discovery Response message.

The UE-to-UE Relay Discovery Response message sent by Relay3 may include one or more of: direct discovery set of discoverer and discoveree End UEs (here, UE1 and UE2), Source Layer-2 ID of discoverer End UE (here, UE1), Source Layer-2 ID of the discoveree End UE (here, UE2), previous hops Routing Information (here, User Info ID of Relay3), next hops Routing Information (here, User Info ID of Relay2), hop count from the discoveree End UE (hop count received in the Response message plus 1; here, hop count=1), RSC, and others.

Relay3 may add/include/append itself to the end of the previous hops Routing Information (i.e., the last U2U Relay in the previous hops Routing Information is the sender U2U Relay). Relay3 may remove itself from the next hops Routing Information in the received UE-to-UE Relay Discovery Response message.

The Source Layer-2 ID of the discoveree End UE may be determined based on the Source Layer-2 ID of the received UE-to-UE Relay Discovery Response message and may be included such that Relay3 may use as the Destination Layer-2 ID of target End UE to unicast the Direct Communication Request (DCR) message to the target End UE during link establishment.

The UE-to-UE Relay Discovery Response message may be protected using the security materials associated with the RSC.

Relay2e may receive the UE-to-UE Relay Discovery Response message 645 from Relay3. Relay2e may process the received message using the discovery security materials associated with the RSC. If the RSC matches the authorized information, Relay2e may process the direct discovery set of discoverer and discoveree End UEs using direct discovery security materials.

If discoverer End UE's User Info ID in the direct discovery set does not match Relay2e's End UE User Info ID (here, User Info ID of Relay2e), Relay2e may store the route to UE2 in the Direct Discovery Routing Table 650.

Relay2e's Direct Discovery Routing Table (with matching RSC) entry to UE2 (discoveree End UE) may include one or more of: Destination End UE, which may be the User Info ID of UE2; Destination End UE Layer-2 ID, which may be the Source Layer-2 ID of UE2; number of hops to Destination End UE, where the received hop count value increased by 1 (here, 2); next hops Routing Information, which may be the User Info ID of Relay3 (set to the received previous hops Routing Information in the received UE-to-UE Relay Discovery Response message in reverse order)

Relay2e may send a UE-to-UE Relay Discovery Response message 655 to Relay1 based on the information in the Direct Discovery Routing Table entry to UE1 (discoverer End UE).

The UE-to-UE Relay Discovery Response message sent by Relay2e may include one or more of: direct discovery set of discoverer and discoveree End UEs (here, UE1 and UE2), Source Layer-2 ID of the discoverer End UE (here, UE1), Source Layer-2 ID of the discoveree End UE (here, UE2), previous hops Routing Information (here, User Info ID of Relay2), next hops Routing Information (here, User Info ID of Relay1), hop count from the discoveree End UE (hop count in the received Response message plus 1; here hop count=2), RSC, and others.

The direct discovery set of discoverer and discoveree End UEs may be protected using direct discovery security materials. The UE-to-UE Relay Discovery Response message may be protected using the security materials associated with the RSC.

Relay1 602 may receive the UE-to-UE Relay Discovery Response message 655 from Relay2e. Relay1 may process the received message using the discovery security materials associated with the RSC. If the RSC matches the authorized information, Relay1 may send a UE-to-UE Relay Discovery Response message 660 to UE1.

The UE-to-UE Relay Discovery Response message may be sent using the received Source Layer-2 ID of the discoverer End UE in the received UE-to-UE Relay Discovery Response message as the Destination Layer-2 ID.

Relay1 is the only U2U Relay of the next hops Routing Information in the received UE-to-UE Relay Discovery Response message and Relay1 does not maintain a Direct Discovery Routing Table (with matching RSC) which may imply that Relay1 is directly connected to the discoverer End UE.

The UE-to-UE Relay Discovery Response message sent by Relay1 may include one or more of: direct discovery set of discoverer and discoveree End UEs (here, UE1 and UE2), Source Layer-2 ID of the discoveree End UE (here, UE2), previous hops Routing Information (here, User Info ID of Relay2, User Info ID of Relay1), hop count from the discoveree End UE (hop count in the received Response message plus 1; here, hop count=3), RSC, and others.

Relay1 may add/include/append itself to the end of the previous hops Routing Information, (i.e., the last U2U Relay in the previous hops Routing Information is the sender U2U Relay).

Relay1 may remove itself out of the next hops Routing Information in the received UE-to-UE Relay Discovery Response message. Here, next hops Routing Information becomes Null and is omitted in the outgoing UE-to-UE Relay Discovery Response message. The next hops Routing Information is not included in the outgoing UE-to-UE Relay Discovery Response message and indicates that Relay1 is directly connected to the discoverer End UE.

The UE-to-UE Relay Discovery Response message may be protected using the security materials associated with the RSC.

UE1 (discoverer End UE) 601 may receive the UE-to-UE Relay Discovery Response message 660 from Relay1. UE1 may process the received message using the discovery security materials associated with the RSC. If the RSC matches the authorized information, UE1 may process the direct discovery set of discoverer and discoveree End UEs using direct discovery security materials.

If discoverer End UE's User Info ID in the direct discovery set matches UE1's User Info ID, UE1 may store the route to UE2 in a Direct Discovery Routing Table 665.

UE1's Direct Discovery Routing Table (with matching RSC) entry to UE2 (discoveree End UE) may include one or more of: Destination End UE, which may be the User Info ID of UE2; Destination End UE Layer-2 ID, which may be the Source Layer-2 ID of UE2; number of Hops to Destination End UE, where the received hop count value increased by 1 (here, 4); next hops Routing Information: User Info ID of Relay1, User Info ID of Relay2 (set to the received previous hops Routing Information in the received UE-to-UE Relay Discovery Response message in reverse order).

To cope with UE mobility in a UE-to-UE-Relay mesh network, each route entry in the Direct Discovery Routing Table may time-out after a preconfigured validity time period. Routes may be updated when receiving new UE-to-UE Relay Discovery Solicitation/Response messages. Upon the time-out of a discovery route entry to a Destination End UE in the Direct Discovery Routing Table of an End UE or an intermediate End UE serving as U2U Relay, the End UE/intermediate End UE may also perform UE-to-UE Relay Discovery to update its discovery route entry to the corresponding Destination End UE.

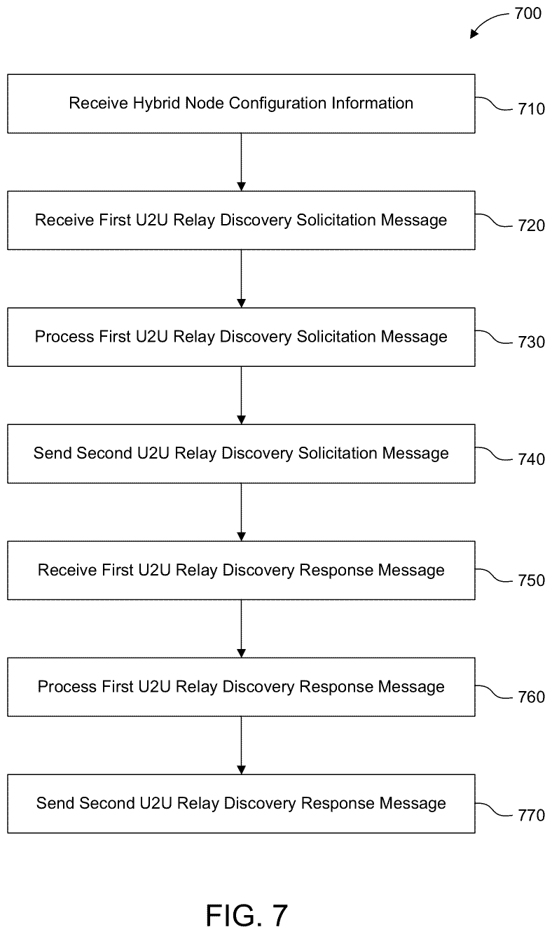

FIG. 7 shows an example method for heterogeneous multihop UE-to-UE (U2U) relay discovery for use by a hybrid node UE. FIG. 7 shows an example method 700 for heterogeneous multihop UE-to-UE (U2U) relay discovery for use by a hybrid node UE (i.e. an end UE which also serves as a U2U relay) for example, Relay2e as shown in FIG. 2. A UE may receive a configuration message 710. The configuration message may comprise hybrid node configuration information. The configuration message may comprise an indication (e.g. flag) for the UE to also serve as a U2U relay. The configuration message may comprise configuration information for the UE to serve as a U2U relay. The end UE which also serves as a U2U relay, may be referred to as a hybrid node or a hybrid UE. The UE may send capability information to the network indicating its capability to act as a hybrid UE. The UE may send the capability information, for example, when registering with the network. The UE may receive the (hybrid node) configuration message in response to or based on the sending the capability information.

The hybrid UE may receive a first solicitation message 720. The first solicitation message may be a U2U relay discovery solicitation message. The hybrid UE may receive the first solicitation message from a first U2U relay (relay 1). The first solicitation message may comprise one or more direct discovery sets. For example, the first solicitation message may comprise a direct discovery set of discoverer end UE (UE1) and discoveree end UE (UE2). Alternatively, the first solicitation message may comprise a direct discovery set of a discoverer end UE (UE1) and a direct discovery set of a discoveree end UE (UE2). A direct discovery set may be protected using discovery security materials. The first solicitation message may comprise the source layer-2 ID of discoverer end UE (UE1). The first solicitation message may comprise a previous hops routing information, for example User Info ID of relay 1. Previous hops routing information may comprise the sequence of user info ID(s) of U2U relay(s) associated with UE1 accumulated hop-by-hop from the closest previous end UE (either an intermediate hybrid UE or UE1) when propagating the U2U relay discovery solicitation message. The first solicitation message may comprise a hop count from UE1. The first solicitation message may comprise a maximum hops allowed parameter. The first solicitation message may comprise a relay service code (RSC). The first solicitation message may be protected using discovery security material associated with the RSC.

The hybrid UE may process the first solicitation message 730. The hybrid UE may process the first solicitation message using the discovery security material associated with the RSC. The hybrid UE may process the direct discovery sets using direct discovery security materials. The hybrid UE may store an entry/route to UE1 in a direct discovery routing table. The route may be based on previous hops routing information. Then entry in the direct discovery routing table for UE1 may include: the destination end UE (e.g. user info ID of UE1); the destination end UE Layer-2 ID (e.g. source Layer-2 ID of UE1); a number of hops to the destination end UE (e.g. received hop count value increased by 1); and a next hops routing information (e.g. user info ID of relay1, set to the previous hops routing information in the received U2U relay discovery solicitation message in reverse order). The hybrid UE may then clear the received previous hops routing information. When the same direct discovery sets are received from different U2U relays or candidate end UEs acting as U2U relays (i.e., other hybrid UEs), or directly from the discoverer end UE (UE1), the hybrid UE may select a route to be put in the direct discovery routing table for the route entry to the discoverer end UE (UE1) based on various criteria, for example, a minimum hop count value or a channel quality of the received U2U relay discovery solicitation message. They hybrid UE may determine the previous hops routing information in the U2U relay discovery solicitation message to be sent to next hop based on the selected route. The hybrid UE may then clear the received previous hops routing information.

The hybrid UE may send a second solicitation message 740. The second solicitation message may be a U2U relay discovery solicitation message. The hybrid UE may send the second solicitation message if the direct discovery routing table does not have a route to UE2 (discoveree end UE). The second solicitation message may be sent to a second U2U relay (relay 3). The U2U relay discovery solicitation message may include one or more of: direct discovery set of discoverer end UE (UE1) and discoveree end UE (UE2), source Layer-2 ID of discoverer end UE (UE1), previous hops routing information (e.g. U2U relay user info ID of the hybrid UE), hop count from the discoverer end UE (UE1) (e.g. hop count in the received discovery solicitation message plus 1), a maximum number of hops allowed, and an RSC. When the received hop count value increased by 1 exceeds the maximum number of hops allowed, the received U2U relay discovery solicitation message may be discarded. The direct discovery set of discoverer end UE and discoveree end UE may be protected using direct discovery security materials. The U2U relay discovery solicitation message may be protected using the security materials associated with the RSC.

If the direct discovery routing table already has a route to UE2 (discoveree end UE), the hybrid UE may reply to UE1 (discoverer end UE) with a U2U relay discovery response message. The U2U relay discovery response message may include one or more of: direct discovery set of discoverer end UE (UE1) and discoveree end UE (UE2), source Layer-2 ID of the discoverer end UE (UE1), source Layer-2 ID of the discoveree end UE (UE2, as stored in the direct discovery routing table entry to the discoveree end UE and to be used as the destination Layer-2 ID of the target end UE in the direct communication request message during link establishment), previous hops routing information (e.g. U2U relay user info ID of the hybrid UE), next hops routing information (e.g. user info ID of Relay1, based on the information in the direct discovery routing table entry to the discoverer end UE), hop count from the discoveree end UE (hop count stored in the direct discovery routing table entry to UE2), RSC, and others. The hybrid UE's direct discovery routing table (with matching RSC) entry to UE2 (discoveree End UE) may include one or more of: destination end UE: user info ID of UE2, destination end UE layer-2 ID: source Layer-2 ID of UE2, number of hops to destination end UE: 2, next hops routing information: user info ID of Relay3.

If hop count value to UE2 in the direct discovery routing table plus the received hop count value increased by 1 exceeds the maximum number of hops allowed received in the U2U relay discovery solicitation message, the hybrid UE may not send the U2U relay discovery response message to UE1.

If the direct discovery routing table of the hybrid UE already has a route to UE2 (discoveree End UE), the hybrid UE may also send (via unicast) a U2U relay discovery gratuitous response message to UE2 to allow the setup of a reverse route from UE2 to UE1 (discoverer End UE). The U2U relay discovery gratuitous response message may include one or more of: direct discovery set of discoverer end UE (UE1) and discoveree end UE (UE2), source Layer-2 ID of the discoveree end UE (UE2, as stored in the direct discovery routing table entry to the discoveree end UE and to be used as the destination layer-2 ID of target end UE by Relay3 to send the U2U relay discovery gratuitous response message to UE2), previous hops routing information (e.g. U2U relay user info ID of the hybrid UE), next hops routing information (as stored in the direct discovery routing table entry to the discoveree end UE, here, User Info ID of Relay3), hop count from the discoverer end UE (hop count stored in the direct discovery routing table entry to UE1), RSC, and others. If the hop count value to UE2 in the direct discovery routing table plus the received hop count value increased by 1 exceeds the maximum number of hops allowed received in the U2U relay discovery solicitation message, the hybrid UE may not send the U2U relay discovery gratuitous response message to UE2.

The hybrid UE may receive a first response message 750. The first response message may be a first U2U relay discovery response message. The first response message may be received from the second U2U relay (relay 3). The first response message may include one or more of: direct discovery sets of UE1 and UE2, source layer-2 ID of UE1, source layer-2 ID of UE2, previous hops routing info (e.g. user info ID of second relay), next hops routing info (U2U relay user info ID of the hybrid UE), hop count from UE2, RCS, and others. The user info ID of the second relay (Relay3) may be appended to end of the previous hops routing information in the received first response message. In this case, the last U2U relay in the previous hops routing information is the sender U2U Relay. In addition, the user info ID of Relay3 may be removed from the next hops routing information in the received first response message. A source layer-2 ID of the discoveree End UE (which may be determined by Relay3 based on the source layer-2 ID of the received first response message from the discoveree End UE) may be included such that Relay3 may use as the destination layer-2 ID of target end UE during unicast link establishment. The first response message may be protected using the security materials associated with the RSC.

The hybrid UE may process the received first response message 760. The hybrid UE may process the received first response message using the discovery security materials associated with the RSC. If the RSC matches the authorized information, the hybrid UE may process the direct discovery set of discoverer and discoveree end UEs using direct discovery security materials. The hybrid UE may store a route to discoveree End UE 2 in the direct discovery routing table. The route may be based on previous hops routing information. The direct discovery routing table (with matching RSC) entry to UE2 (discoveree End UE) may include one or more of: destination end UE: User Info ID of UE2; destination end UE layer-2 ID: source layer-2 ID of UE2; number of hops to destination end UE: received hop count value increased by 1; and next hops routing information: User Info ID of Relay3 (set to the received previous hops routing information in the received first response message in reverse order).

The hybrid UE may send a second response message 770. The second response message may be a second U2U relay discovery response message. The second response message may be sent to the first U2U relay (relay 1). The second response message may be based on information in the direct discovery routing table entry to UE1 (discoverer end UE). The second response message may include one or more of: direct discovery sets of UE1 and UE2, source layer-2 ID of UE1. source layer-2 ID of UE2, previous hops routing information (U2U relay user info ID of the hybrid UE), next hops routing information (user info ID of first relay 1), hop count from UE2 (discoveree end UE), RSC, and others. The direct discovery set of discoverer end UE and discoveree end UE may be protected using direct discovery security materials. The second response message may be protected using the security materials associated with the RSC.

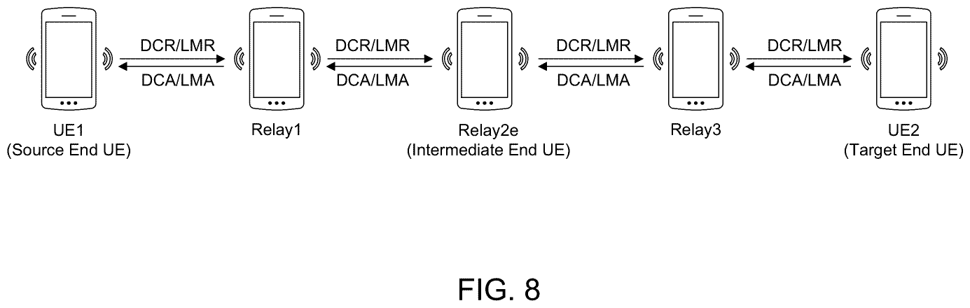

FIG. 8 shows an example configuration for heterogeneous multihop UE-to-UE Relay Link Establishment.

Relay2e may be authorized and configured as a hybrid node (End UE serving as a U2U Relay).

A source End UE (UE1) may send a Direct Communication Request (DCR) or Link Modification Request (LMR) message based on the next hops Routing Information (with sequence of U2U Relay User Info IDs) in its Direct Discovery Routing Table.

A U2U Relay that is not an End UE (Relay1, Relay 3) may send the DCR or LMR message based on the next hops Routing Information provided in the received DCR/LMR message.

An intermediate End UE serving as a U2U Relay (Relay2e) may send the DCR or LMR message based on the next hops Routing Information (with sequence of U2U Relay User Info IDs) in its Direct Discovery Routing Table.

After receiving the LMR message or during security establishment after receiving the DCR message on each hop, the receiving U2U Relay or target End UE may add a route entry to the source End UE in a Unicast Routing Table.

The target End UE (UE2) may send Direct Communication Accept (DCA) or Link Modification Accept (LMA) to the source End UE hop by hop based on the next hop information in the Unicast Routing Table on each hop.

After receiving the DCA or LMA message, the receiving U2U Relay or source End UE may add a route entry to the target End UE in its Unicast Routing Table on each hop.

Referring to FIG. 8, for UE1 (Source End UE), the User Info ID of UE1 may represent the End UE User Info ID of UE1. UE1 may sends a DCR or LMR message to Relay1. The DCR or LMR message may include one or more of: User Info ID of source End UE (here, UE1), next hops Routing Information (here, User Info ID of Relay1, User Info ID of Relay2), User Info ID and Destination Layer-2 ID of target End UE (here, UE2), hop count from the source End UE (here, hop count=0), RSC, and others, based on the information in its Direct Discovery Routing Table. UE1 may receive a DCA or LMA message from Relay1. UE1 may add a route entry to UE2 into its Unicast Routing Table (with matching RSC). UE1 may requests an IP address from Relay1 for Layer-3 UE-to-UE Relay Communication with IP traffic.

For Relay1 (U2U Relay UE), the User Info ID of Relay1 may represent the U2U Relay User Info ID of Relay1. Relay1 may receive the DCR or LMR message from UE1. Relay 1 may perform security establishment with UE1 if a DCR is received. Relay1 may add a route entry to UE1 into its Unicast Routing Table (with matching RSC). Relay1 may send the DCR or LMR message to Relay2e, which may include a User Info ID of the source End UE (here, UE1), User Info ID of sender U2U Relay (here, Relay1), next hops Routing Information (here, User Info ID of Relay2), User Info ID and Destination Layer-2 ID of target End UE (here, UE2), hop count from the source End UE (here, hop count=1), RSC, and others. Relay1 may receive a DCA or LMA message from Relay2e. Relay1 may add a route entry to UE2 into its Unicast Routing Table (with matching RSC). Relay1 may send the DCA or LMA message to UE1, which may include one or more of: the User Info ID of the source End UE (here, UE1), User Info ID of the sender U2U Relay (here, Relay1), User Info ID of target End UE (here, UE2), based on the next hop information to UE1 in its Unicast Routing Table (with matching RSC). Relay1 may assign an IP address (acting as a DHCP server or IPv6 Router) for UE1, if requested.

For Relay2e (End UE serving as U2U Relay-hybrid node), the User Info ID of Relay2e may represent the End UE User Info ID of Relay2e and the User Info ID of Relay2 may represent the U2U Relay User Info ID of Relay2e. Relay2e may receive the DCR or LMR message from Relay1. Relay2e may perform security establishment with Relay1 if a DCR is received. Relay2e may add a route entry to UE1 into its Unicast Routing Table (with matching RSC). Relay2e may send a DCR or LMR message to Relay3, which may include one or more of: User Info ID of source End UE (here, UE1), User Info ID of sender U2U Relay (here, User Info ID of Relay2), next hops Routing Information (here, User Info ID of Relay3), User Info ID and Destination Layer-2 ID of target End UE (here, UE2), hop count from the source End UE (here, hop count=2), RSC, and others, based on the information in its Direct Discovery Routing Table. Relay2e may receive a DCA or LMA message from Relay3. Relay2e may add a route entry to UE2 into its Unicast Routing Table (with matching RSC). Relay2e may send the DCA or LMA message to Relay1, which may include one or more of: User Info ID of source End UE (here, UE1), User Info ID of sender U2U Relay (here, Relay2e), User Info ID of target End UE (here, UE2), hop count from the target End UE (here, hop count=2), RSC, and others, based on the next hop information to UE1 in its Unicast Routing Table (with matching RSC).

For Relay3 (U2U Relay UE), the User Info ID of Relay3 may represent the U2U Relay User Info ID of Relay3. Relay3 may receive the DCR or LMR message from Relay2e. Relay3 may perform security establishment with Relay2e if a DCR is received. Relay3 may add a route entry to UE1 into its Unicast Routing Table (with matching RSC). Relay3 may send a DCR or LMR message to UE2, which may include one or more of: User Info ID of source End UE (here, UE1), User Info ID of sender U2U Relay (here, Relay3), User Info ID of target End UE (here, UE2), hop count from the source End UE (here, hop count=3), RSC and others. Relay3 may apply the Destination Layer-2 ID of target End UE, if received from Relay2e, when sending a DCR. Relay3 may receive a DCA or LMA message from UE2. Relay3 may add a route entry to UE2 into its Unicast Routing Table (with matching RSC). Relay3 may send the DCA or LMA message to Relay2e, which may include one or more of: User Info ID of source End UE (here, UE1), User Info ID of sender U2U Relay (here, Relay3), User Info ID of target End UE (here, UE2), hop count from the target End UE (here, hop count=1), RSC, and others, based on the next hop information to UE1 in its Unicast Routing Table (with matching RSC). Relay3 may assign an IP address (acting as a DHCP server or IPv6 Router) for UE2, if requested.

For UE2 (Target End UE), the User Info ID of UE2 may represent the End UE User Info ID of UE2. UE2 may receive the DCR or LMR message from Relay3. UE2 may perform security establishment with Relay3. UE2 may add a route entry to UE1 into its Unicast Routing Table (with matching RSC). UE2 may send the DCA or LMA message to Relay3, which may include one or more of: User Info ID of source End UE (here, UE1) and User Info ID of target End UE (here, UE2), hop count from the target End UE (here, hop count=0), RSC, and others, based on the next hop information to UE1 in its Unicast Routing Table (with matching RSC). UE2 may request an IP address from Relay3 for Layer-3 UE-to-UE Relay Communication with IP traffic.

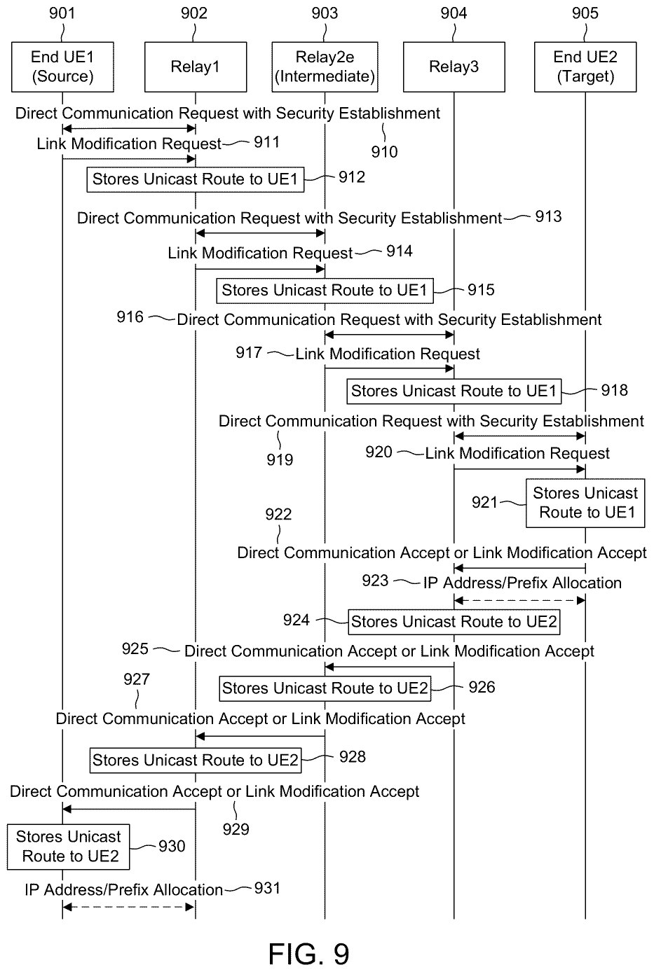

FIG. 9 shows an example Heterogeneous multihop UE-to-UE Relay Link Establishment procedure.

To send a Direct Communication Request (DCR) or Link Modification Request (LMR) message for a hop-by-hop link establishment, a source End UE or an intermediate End UE serving as a U2U Relay may include the Routing Information to the next End UE (either an intermediate End UE serving as a U2U Relay or the Destination End UE itself) in a DCR/LMR message based on its local Direct Discovery Routing Table. U2U Relays not provisioned with direct discovery security materials may use the Routing Information provided in the DCR/LMR to determine the next hop. After receiving an LMR or during security establishment after receiving a DCR on each hop, the receiving U2U Relay or target End UE may add a route entry to the source End UE in a Unicast Routing Table, which may be utilized by the target End UE and U2U Relays to send a Direct Communication Accept (DCA) or Link Modification Accept (LMA) message to the source End UE hop by hop.

Service authorization and provisioning may be performed for UE1 (source End UE) 901, UE2 (target End UE) 905, Relay1 902, Relay2e 903, and Relay3 904. UE1 may have discovered UE2 via UE-to-UE Relay Discovery (here, [UE1, Relay1, Relay2e, Relay3, UE2]). Relay2e may be authorized and configured as a hybrid node (End UE serving as a U2U Relay). For Relay2e serving as a U2U Relay, the User Info ID of Relay2 is used as the U2U Relay User Info ID and is not protected with the direct discovery security materials. For Relay2e serving as an End UE, the User Info ID of Relay2e is used as the End UE User Info ID and is protected with the direct discovery security materials.

UE1 901 may send a Direct Communication Request (DCR) 910 or Link Modification Request (LMR) message 911 to Relay1 902, based on the information in the Direct Discovery Routing Table (with matching RSC). UE1's Direct Discovery Routing Table entry to UE2 (target End UE) 905 may include one or more of: Destination End UE: User Info ID of UE2; Destination End UE Layer-2 ID: Source Layer-2 ID of UE2; number of Hops to Destination End UE: here 4; next hops Routing Information: User Info ID of Relay1, User Info ID of Relay2.

If a PC5 connection between UE1 and Relay1 does not exist, UE1 may send a DCR message 910 to initiate a PC5 connection setup procedure with Relay1. Otherwise, UE1 may send a LMR message 911 to initiate a PC5 connection modification procedure with Relay1.

The DCR or LMR message sent by UE1 may include one or more of: User Info ID of source End UE (here, UE1), next hops Routing Information (here, User Info ID of Relay1, User Info ID of Relay2), User Info ID and Destination Layer-2 ID of target End UE (here, UE2), hop count from the source End UE (here, hop count=0), RSC, and others. Next hops Routing Information may be set to the next hops Routing Information in the Direct Discovery Routing Table.

If the User Info ID of the first U2U Relay in the next hops Routing Information (here, Relay1) within the received DCR/LMR message matches the U2U Relay User Info ID of Relay1 (here, User Info ID of Relay1), and if the RSC in the received DCR matches any RSC that Relay1 supports, Relay1 may respond by establishing the security with UE1 and add a route entry to UE1 into its Unicast Routing Table (with matching RSC) 912. If the RSC in the received LMR matches any RSC that Relay1 supports, Relay1 may add a route entry to UE1 into its Unicast Routing Table (with matching RSC) 912.

The route entry to UE1 in Relay1's Unicast Routing Table may include one or more of: Destination End UE: User Info ID of UE1; number of hops to Destination End UE: here 1 (hop count in the received DCR/LMR plus 1); next hop: directly connected; and Destination Layer-2 ID of next hop: Source Layer-2 ID of UE1.

Relay1 902 may send a DCR 913 or LMR 914 message to Relay2e 903 based on the next hops Routing Information in the received DCR/LMR message.

If PC5 connection between Relay1 and Relay2e does not exist, Relay1 may send a DCR message to initiate PC5 connection setup procedure 913 with Relay2e. Otherwise, Relay1 may send a LMR message to initiate PC5 connection modification procedure 914 with Relay2e.

The DCR or LMR message sent by Relay1 may include one or more of: User Info ID of source End UE (here, UE1), User Info ID of sender U2U Relay (here, Relay1), next hops Routing Information (here, User Info ID of Relay2), User Info ID and Destination Layer-2 ID of target End UE (here, UE2), hop count from the source End UE (hop count in the received DCR/LMR plus 1; here, hop count=1), RSC, and others.

The sender U2U Relay (here, Relay1) may remove itself from the next hops Routing Information in the received DCR/LMR message (here, Relay1).

If the User Info ID of the first U2U Relay in the next hops Routing Information (here, Relay2) within the received DCR/LMR message matches the U2U Relay User Info ID of Relay2e (here, User Info ID of Relay2), and if the RSC in the received DCR matches any RSC that Relay2e supports, Relay2e may respond by establishing the security with Relay1 and add a route entry to UE1 into its Unicast Routing Table (with matching RSC) 915. If the RSC in the received LMR matches any RSC that Relay2e supports, Relay2e adds a route entry to UE1 into its Unicast Routing Table (with matching RSC) 915.

The route entry to UE1 in Relay2e's Unicast Routing Table may include one or more of: Destination End UE: User Info ID of UE1; number of hops to Destination End UE: here 2 (hop count in the received DCR/LMR plus 1); next hop: User Info ID of Relay1 (User Info ID of sender U2U Relay in the received DCR/LMR); Destination Layer-2 ID of Next Hop: Source Layer-2 ID of Relay1.

Relay2e 903 may send a DCR 916 or LMR 917 message to Relay3 904, based on the information in the Direct Discovery Routing Table (with matching RSC). Relay2e's Direct Discovery Routing Table entry to UE2 (target End UE) may include one or more of: Destination End UE: User Info ID of UE2; Destination End UE Layer-2 ID: Source Layer-2 ID of UE2; number of hops to Destination End UE: here 2; and next hops Routing Information: User Info ID of Relay3.

If a PC5 connection between Relay2e and Relay3 does not exist, Relay2e may send a DCR message to initiate PC5 connection setup procedure 916 with Relay3. Otherwise, Relay2e may send a LMR message to initiate PC5 connection modification procedure 917 with Relay3.

The DCR or LMR message sent by Relay2e may include one or more of: User Info ID of source End UE (here, UE1), User Info ID of sender U2U Relay (here, User Info ID of Relay2), next hops Routing Information (here, User Info ID of Relay3), User Info ID and Destination Layer-2 ID of target End UE (here, UE2), hop count from the source End UE (hop count in the received DCR/LMR plus 1; here, hop count=2), RSC, and others.

Next hops Routing Information may be set to the next hops Routing Information in the Direct Discovery Routing Table.

If the User Info ID of the first U2U Relay in the next hops Routing Information (here, Relay3) within the received DCR/LMR message matches the U2U Relay User Info ID of Relay3 (here, User Info ID of Relay3), and if the RSC in the received DCR matches any RSC that Relay3 supports, Relay3 responds by establishing the security with Relay2e and add a route entry to UE1 into its Unicast Routing Table (with matching RSC) 918. If the RSC in the received LMR matches any RSC that Relay3 supports, Relay3 may add a route entry to UE1 into its Unicast Routing Table (with matching RSC) 918.

The route entry to UE1 in Relay3's Unicast Routing Table may include one or more of: Destination End UE: User Info ID of UE1; number of hops to Destination End UE: here 3 (hop count in the received DCR/LMR plus 1); next hop: User Info ID of Relay2 (User Info ID of sender U2U Relay in the received DCR/LMR); and Destination Layer-2 ID of Next Hop: Source Layer-2 ID of Relay2e.

If Relay3 is the only U2U Relay in the next hops Routing Information within the received DCR/LMR message, and Relay3 does not maintain a Direct Discovery Routing Table (with matching RSC), Relay3 may send a DCR 919 or LMR 920 message to the target End UE (here, UE2).

If a PC5 connection between Relay3 and UE2 does not exist, Relay3 may send a DCR message to initiate PC5 connection setup procedure 919 with UE2. Otherwise, Relay3 may send a LMR message to initiate PC5 connection modification procedure 920 with UE2.

If a PC5 connection between Relay3 and UE2 does not exist, and if the Destination Layer-2 ID of target End UE (here, UE2) is provided in the received DCR/LMR message, Relay3 may send a DCR message via unicast to initiate the PC5 connection setup procedure with UE2. On the other hand, if the Destination Layer-2 ID of target End UE (here, UE2) is not provided in the received DCR/LMR message, Relay3 may send a DCR message via broadcast to initiate the PC5 connection setup procedure with UE2.

The DCR or LMR message sent by Relay3 may include one or more of: User Info ID of source End UE (here, UE1), User Info ID of sender U2U Relay (here, Relay3), User Info ID of target End UE (here, UE2), hop count from the source End UE (hop count in the received DCR/LMR plus 1; here, hop count=3), RSC, and others.

The sender U2U Relay (here, Relay3) may remove itself from the next hops Routing Information in the received DCR/LMR message (here, Relay1). Here, next hops Routing Information becomes Null and is omitted in the outgoing DCR.

If the User Info ID of the target End UE included in the DCR/LMR message matches UE2's User Info ID, UE2 may add a route entry to UE1 into its Unicast Routing Table (with matching RSC) 921.

If the RSC in the received DCR matches any RSC that UE2 supports, UE2 may respond by establishing the security with Relay3 and then adds a route entry to UE1 into its Unicast Routing Table (with matching RSC) 921. If the RSC in the received LMR matches any RSC that UE2 supports, UE2 may add a route entry to UE1 into its Unicast Routing Table (with matching RSC) 921.

The route entry to UE1 in UE2's Unicast Routing Table may include one or more of: Destination End UE: User Info ID of UE1 (source End UE); number of hops to Destination End UE: here 4 (hop count in the received DCR/LMR plus 1); next hop: User Info ID of Relay3 (User Info ID of sender U2U Relay in the received DCR/LMR); Destination Layer-2 ID of next hop: Source Layer-2 ID of Relay3.

UE2 905 may send a Direct Communication Accept (DCA) or Link Modification Accept (LMA) message 922 to Relay3 904 based on the next hop information of the route entry to UE1 (source End UE) in its Unicast Routing Table (with matching RSC).

UE2's Unicast Routing Table entry to UE1 (source End UE) may include one or more of: Destination End UE: User Info ID of UE1; number of hops to Destination End UE: here 4; next hop: User Info ID of Relay3; and Destination Layer-2 ID of Next Hop: Source Layer-2 ID of Relay3.

If a PC5 connection between UE2 and Relay3 does not exist, UE2 may send a DCA message 922 to Relay3. Otherwise, UE2 may send a LMA message 922 to Relay3.

The DCA/LMA message sent by UE2 may include one or more of: User Info ID of source End UE (here, UE1) and User Info ID of target End UE (here, UE2), hop count from the target End UE (here, hop count=0), RSC, and others.

For Layer-3 UE-to-UE Relay Communication with IP traffic, an IPv6 prefix or IPv4 address may be allocated 923 for the target End UE (here, UE2) by, for example, Relay3.

Relay3 may receive the DCA/LMA message from UE2 and add a route entry to UE2 into its Unicast Routing Table (with matching RSC) 924.

The route entry to UE2 in Relay3's Unicast Routing Table may include one or more of: Destination End UE: User Info ID of UE2; number of hops to Destination End UE: 1 (hop count in the received DCA/LMA plus 1); next hop: directly connected; Destination Layer-2 ID of Next Hop: Source Layer-2 ID of UE2.

Relay3 may send a DCA or LMA message 925 to Relay2e based on the next hop information of the route entry to UE1 (source End UE) in its Unicast Routing Table (with matching RSC).

Relay3's Unicast Routing Table entry to the source End UE (here, UE1) may include one or more of: Destination End UE: User Info ID of UE1; number of hops to Destination End UE: here 3; next hop: User Info ID of Relay2; and Destination Layer-2 ID of Next Hop: Source Layer-2 ID of Relay2e.

If a PC5 connection between Relay3 and Relay2e does not exist, Relay3 sends a DCA message 925 to Relay2e. Otherwise, Relay3 sends a LMA message 925 to Relay2e.

The DCA/LMA message sent by Relay3 may include one or more of: User Info ID of source End UE (here, UE1); User Info ID of target End UE (here, UE2); User Info ID of sender U2U Relay (here, Relay3); hop count from the target End UE (hop count in the received DCA/LMA plus 1; here, hop count=1); RSC; and others.

Relay2e may receive the DCA/LMA message from Relay3 and add a route entry to UE2 into its Unicast Routing Table (with matching RSC) 926.

The route entry to UE2 in Relay2e's Unicast Routing Table may include one or more of: Destination End UE: User Info ID of UE2; number of hops to Destination End UE: here 2 (hop count in the received DCA/LMA plus 1); next hop: User Info ID of Relay3 (User Info ID of sender U2U Relay in the received DCA/LMA); and Destination Layer-2 ID of Next Hop: Source Layer-2 ID of Relay3.

Relay2e may send a DCA or LMA message to Relay1 based on the next hop information to the source End UE (here, UE1) in its Unicast Routing Table (with matching RSC) 927.

Relay2e's Unicast Routing Table entry to the source End UE (here, UE1) may include one or more of: Destination End UE: User Info ID of UE1; number of hops to Destination End UE: here 2; next hop: User Info ID of Relay1; and Destination Layer-2 ID of Next Hop: Source Layer-2 ID of Relay1.

If a PC5 connection between Relay2e and Relay1 does not exist, Relay2e may send a DCA message 927 to Relay1. Otherwise, Relay2e may send a LMA message 927 to Relay1.

The DCA/LMA message sent by Relay2e may include one or more of: User Info ID of source End UE (here, UE1); User Info ID of target End UE (here, UE2); User Info ID of sender U2U Relay (here, User Info ID of Relay2); hop count from the target End UE (hop count in the received DCA/LMA plus 1; here, hop count=2); RSC; and others.

Relay1 may receive the DCA/LMA message from the Relay2e and add a route entry to the target End UE (here, UE2) into its Unicast Routing Table (with matching RSC) 928.

The route entry to UE2 in Relay1's Unicast Routing Table may include one or more of: Destination End UE: User Info ID of UE2; number of hops to Destination End UE: here 3 (hop count in the received DCA/LMA plus 1); next hop: User Info ID of Relay2 (User Info ID of sender U2U Relay in the received DCA/LMA); and Destination Layer-2 ID of Next Hop: Source Layer-2 ID of Relay2e.

Relay1 may send a DCA or LMA message 929 to UE1 based on the next hop information in its Unicast Routing Table (with matching RSC).

Relay1's Unicast Routing Table entry to the source End UE (here, UE1) may include one or more of: Destination End UE: User Info ID of UE1; number of hops to Destination End UE: 1; next hop: directly connected; Destination Layer-2 ID of Next Hop: Source Layer-2 ID of UE1.

If a PC5 connection between Relay1 and UE1 does not exist, Relay1 may send a DCA message 929 to UE1. Otherwise, Relay1 may send a LMA message 929 to UE1.

The DCA/LMA message sent by Relay1 may include one or more of: User Info ID of source End UE (here, UE1); User Info ID of target End UE (here, UE2); User Info ID of sender U2U Relay (here, Relay1); hop count from the target End UE (hop count in the received DCA/LMA plus 1; here, hop count=3); RSC; and others.

UE1 901 may receive the DCA/LMA message from Relay1 902 and add a route entry to UE2 into its Unicast Routing Table (with matching RSC) 930.

The route entry to UE2 in UE1's Unicast Routing Table may include one or more of: Destination End UE: User Info ID of UE2; number of hops to Destination End UE: here 4 (hop count in the received DCA/LMA plus 1); next hop: User Info ID of Relay1 (User Info ID of sender U2U Relay in the received DCA/LMA); and Destination Layer-2 ID of Next Hop: Source Layer-2 ID of Relay1.

For Layer-3 UE-to-UE Relay Communication with IP traffic, an IPv6 prefix or IPv4 address may be allocated 931 for the source End UE (here, UE1) by for example, Relay1.

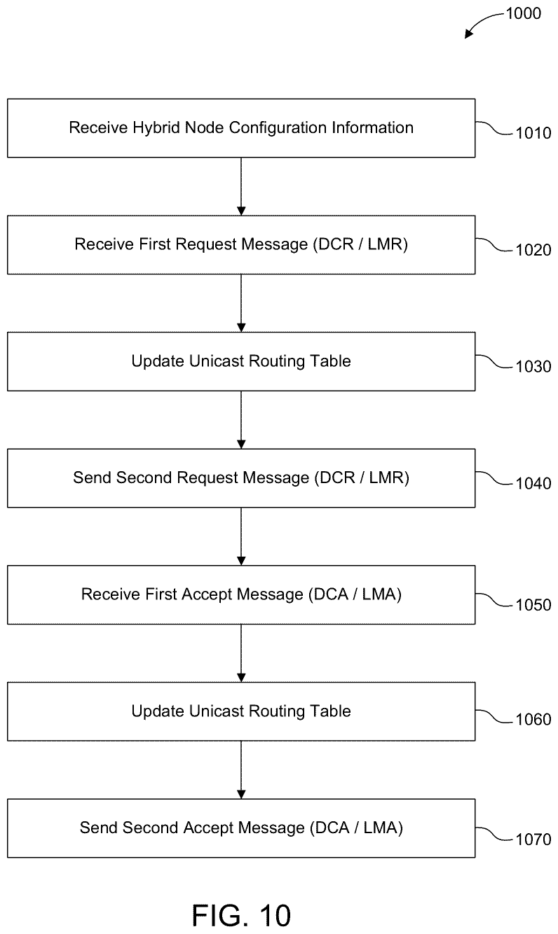

FIG. 10 shows an example method for a heterogeneous multihop UE-to-UE Relay Link Establishment.

A hybrid UE (for example, Relay2e as shown in FIG. 2) may receive a first request message 1020. The first request message may be a Direct Communication Request (DCR) or Link Modification Request (LMR) message. The first request message may be from a first U2U relay (Relay1). If a PC5 connection between Relay1 and the hybrid UE does not exist, the hybrid UE may receive from Relay1 a DCR message to initiate aPC5 connection setup procedure. Otherwise, the hybrid UE may receive from Relay1 a LMR message to initiate a PC5 connection modification procedure.

The DCR or LMR message received from Relay1 may include one or more of: User Info ID of source End UE (UE1), User Info ID of sender U2U Relay (Relay1), next hops Routing Information (U2U relay User Info ID of the hybrid UE, here, User Info ID of Relay2), User Info ID and Destination Layer-2 ID of target End UE (UE2), hop count from the source End UE (hop count in the received DCR/LMR plus 1), RSC, and others. The sender U2U Relay (Relay1) of the first request message may remove itself from the next hops Routing Information before sending the DCR/LMR message.

If the User Info ID of the first U2U Relay in the next hops Routing Information within the received DCR/LMR message matches the U2U Relay User Info ID of the hybrid UE (here, User Info ID of Relay2), and if the RSC in the received DCR matches any RSC that the hybrid UE supports, the hybrid UE may respond by establishing the security with Relay1 and add a route entry to UE1 into its Unicast Routing Table (with matching RSC) 1030. If the RSC in the received LMR matches any RSC that the hybrid UE supports, the hybrid UE may add a route entry to UE1 into its Unicast Routing Table (with matching RSC) 1030.

The route entry to UE1 in the hybrid UE's Unicast Routing Table may include one or more of: Destination End UE: User Info ID of UE1; number of hops to Destination End UE: hop count in the received DCR/LMR plus 1; next hop: User Info ID of Relay1 (User Info ID of sender U2U Relay in the received DCR/LMR); Destination Layer-2 ID of Next Hop: Source Layer-2 ID of Relay1.

The hybrid UE (Relay2e) may send a second request message 1040. The second request message may be a DCR or LMR message. The second request message may be sent to a second U2U relay (Relay3). The second request message may be based on the information in the Direct Discovery Routing Table (with matching RSC). The hybrid UE's Direct Discovery Routing Table entry to a target End UE (UE2) may include one or more of: Destination End UE: User Info ID of UE2; Destination End UE Layer-2 ID: Source Layer-2 ID of UE2; number of hops to Destination End UE; and next hops Routing Information: User Info ID of Relay3.

If a PC5 connection between the hybrid UE and Relay3 does not exist, the hybrid UE may send a DCR message to initiate PC5 connection setup procedure with Relay3. Otherwise, the hybrid UE may send a LMR message to initiate PC5 connection modification procedure with Relay3.

The DCR or LMR message sent by the hybrid UE may include one or more of: User Info ID of source End UE (UE1), User Info ID of sender U2U Relay (U2U relay User Info ID of the hybrid UE), next hops Routing Information (User Info ID of Relay3), User Info ID and Destination Layer-2 ID of target End UE (UE2), hop count from the source End UE (hop count in the received DCR/LMR plus 1), RSC, and others.

Next hops Routing Information may be set to the next hops Routing Information in the Direct Discovery Routing Table.

If the User Info ID of the first U2U Relay in the next hops Routing Information within the received DCR/LMR message matches the U2U Relay User Info ID of Relay3 (here, User Info ID of Relay3), and if the RSC in the received DCR matches any RSC that Relay3 supports, Relay3 responds by establishing the security with the hybrid UE and may add a route entry to UE1 into its Unicast Routing Table (with matching RSC). If the RSC in the received LMR matches any RSC that Relay3 supports, Relay3 may add a route entry to UE1 into its Unicast Routing Table (with matching RSC).

The hybrid UE (Relay2e) may receive a first accept message 1050. The first accept message may be a Direct Communication Accept (DCA) or Link Modification Accept (LMA) message. The first accept message may be received from the second U2U relay (Relay3). If a PC5 connection between Relay3 and the hybrid UE does not exist, the hybrid UE may receive a DCA message. Otherwise, the hybrid UE may receive a LMA message. The DCA/LMA message received may include one or more of: User Info ID of source End UE (UE1); User Info ID of target End UE (UE2); User Info ID of sender U2U Relay (Relay3); hop count from the target End UE (hop count in the received DCA/LMA plus 1); RSC; and others.

The hybrid UE (Relay2e) may and add a route entry to UE2 into its Unicast Routing Table (with matching RSC) 1060. The route entry to UE2 in the hybrid UE's Unicast Routing Table may include one or more of: Destination End UE: User Info ID of UE2; number of hops to Destination End UE: hop count in the received DCA/LMA plus 1; next hop: User Info ID of Relay3 (User Info ID of sender U2U Relay in the received DCA/LMA); and Destination Layer-2 ID of Next Hop: Source Layer-2 ID of Relay3.

The hybrid UE (Relay2e) may send a second accept message 1070. The second accept message may be a DCA or LMA message. The second accept message may be sent to the first U2U relay (Relay1). The second accept message may be based on the next hop information to the source End UE (UE1) in its Unicast Routing Table (with matching RSC).

The hybrid UE's Unicast Routing Table entry to the source End UE (UE1) may include one or more of: Destination End UE: User Info ID of UE1; number of hops to Destination End UE; next hop: User Info ID of Relay1; and Destination Layer-2 ID of Next Hop: Source Layer-2 ID of Relay1.

If a PC5 connection between the hybrid UE and Relay1 does not exist, the hybrid UE may send a DCA message to Relay1. Otherwise, the hybrid UE may send a LMA message to Relay1.

The DCA/LMA message sent by the hybrid UE may include one or more of: User Info ID of source End UE (UE1); User Info ID of target End UE (UE2); User Info ID of sender U2U Relay (U2U relay User Info ID of the hybrid UE); hop count from the target End UE (hop count in the received DCA/LMA plus 1); RSC; and others.

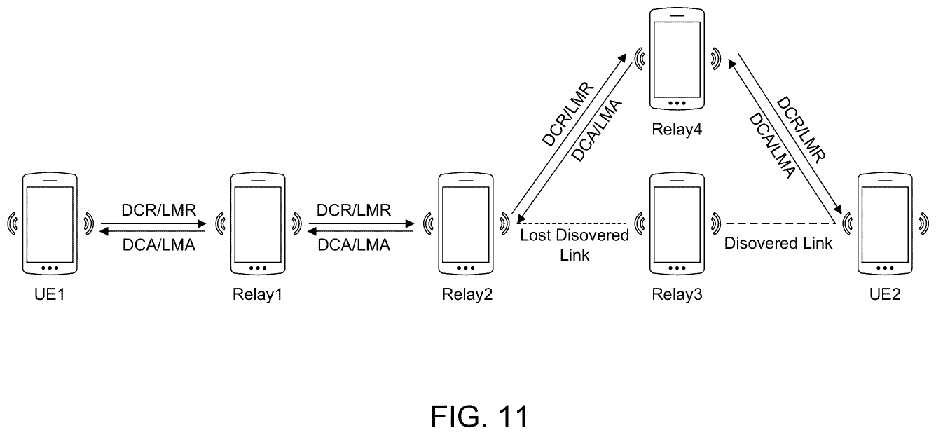

To cope with UE mobility in a UE-to-UE Relay mesh network, each route entry in the Direct Discovery Routing Table may time-out after a preconfigured validity time period. If a source End UE tries to perform hop-by-hop link establishment to a target End UE before an invalid route entry on an intermediate hybrid UE (here, Relay2e) times out, somewhere along the path, a PC5 connection setup may fail. If this happens, the detecting U2U Relay may initiate a local Integrated Discovery procedure to find a new unicast route to the target End UE, based on the target User Info ID received in the DCR/LMR received from the previous hop. After the new unicast route between the detecting U2U Relay and the target End UE is established, the detecting U2U Relay may send a DCA/LMA back to the source End UE. Such a process may be viewed as a multihop link establishment with partial Integrated Discovery, as shown in FIG. 11.

In addition, if local Integrated Discovery is not successful, the detecting U2U Relay may send a Local Integrated Discovery Failure message to the source End UE based on the hop-by-hop Unicast Routing Table to initiate the end-to-end Integrated Discovery procedure. Any U2U Relay receiving the Local Integrated Discovery Failure message may also initiate a local Integrated Discovery procedure to find a new unicast route to the target End UE before sending the Local Integrated Discovery Failure message further upstream if unsuccessful.

Alternatively or additionally, the detecting U2U Relay may send a Link Failure Notification message toward the source End UE based on the hop-by-hop Unicast Routing Table. The first intermediate hybrid UE receiving the Link Failure Notification message (here, Relay2e) may perform the UE-to-UE Relay Discovery procedure to find a new discovery route to the target End UE and update its Direct Discovery Routing Table.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use by a wireless transmit/receive unit (WTRU), the method comprising:
receiving hybrid node configuration information, wherein the hybrid node configuration information comprises an indication for the WTRU to perform as a WTRU-to-WTRU relay and an end WTRU;
receiving a first message from a first WTRU-to-WTRU relay, wherein the first message comprises at least one direct discovery set, wherein the at least one direct discovery set comprises a list of end WTRU user information identifications (IDs) of end WTRUs, wherein the first message comprises a list of previous hops routing information for each end WTRU that indicates a sequence of user information IDs of WTRU-to-WTRU relays associated with an end WTRU, and wherein the first message comprises a list of hop counts for each end WTRU in the list of end WTRUs;
processing the first message, wherein the processing the first message comprises storing a route to each end WTRU in a direct discovery routing table based on the previous hops routing information; and
sending a second message to a second WTRU-to-WTRU relay, wherein the second message comprises the at least one direct discovery set, wherein the at least one direct discovery set comprises a list of end WTRU user information IDs of end WTRUs, wherein the WTRU announces itself as an end WTRU by including its end WTRU user information ID in the at least one direct discovery set in the second message.

2. The method of claim 1, wherein the WTRU is associated with a WTRU-to-WTRU relay user information identification (ID) as a relay WTRU and wherein the WTRU is associated with an end WTRU user information ID as an end WTRU.

3. The method of claim 1, further comprising:
sending capability information to a network node, wherein the capability information indicates a capability for the WTRU to perform as a WTRU-to-WTRU relay and an end WTRU; and
receiving the hybrid node configuration information in response to sending the capability information.

4. The method of claim 1, wherein the at least one direct discovery set is protected based on direct discovery security materials associated with a ProSe direct discovery service for restricted ProSe direct discovery.

5. The method of claim 1, wherein the first message is a first WTRU-to-WTRU relay discovery announcement message, and wherein the second message is a second WTRU-to-WTRU relay discovery announcement message.

6. The method of claim 1, wherein the WTRU is provisioned with direct discovery security materials associated with a ProSe direct discovery service for restricted ProSe direct discovery and wherein the processing the first message comprises:
processing the at least one direct discovery set using the direct discovery security materials.

7. The method of claim 1, wherein the WTRU provides, for a destination end WTRU in the direct discovery routing table: a user information ID of the destination end WTRU, a source layer-2 ID associated with the destination end WTRU, a number of hops to the destination end WTRU, and a next hops routing information, wherein the next hops routing information is set to the previous hops routing information in reverse order.

8. The method of claim 1, wherein the previous hops routing information comprises a sequence of user information IDs of WTRU-to-WTRU relays associated with an announcing end WTRU accumulated hop by hop from a closest previous end WTRU when propagating a WTRU-to-WTRU relay discovery message, wherein a closest previous end WTRU is an intermediate hybrid WTRU or the announcing end WTRU.

9. The method of claim 1, wherein the processing the first message comprises updating a route to an end WTRU in the direct discovery routing table based on a minimum hop count value or a channel quality of the received first message.

10. The method of claim 1, wherein the WTRU is a hybrid WTRU, wherein the hybrid WTRU performs as an End WTRU and a WTRU-to-WTRU relay.

11. A wireless transmit/receive unit (WTRU) comprising:
a receiver;
a processor; and
a transmitter, wherein:
the receiver is configured to receive hybrid node configuration information, wherein the hybrid node configuration information comprises an indication for the WTRU to perform as a WTRU-to-WTRU relay and an end WTRU;
the receiver is further configured to receive a first message from a first WTRU-to-WTRU relay, wherein the first message comprises at least one direct discovery set, wherein the at least one direct discovery set comprises a list of end WTRU user information identifications (IDs) of end WTRUs, wherein the first message comprises a list of previous hops routing information for each end WTRU that indicates a sequence of user information IDs of WTRU-to-WTRU relays associated with an end WTRU, and wherein the first message comprises a list of hop counts for each end WTRU in the list of end WTRUs;
the processor is configured to process the first message, wherein the processor is configured to store a route to each end WTRU in a direct discovery routing table based on the previous hops routing information; and
the transmitter is configured to send a second message to a second WTRU-to-WTRU relay, wherein the second message comprises the at least one direct discovery set wherein the at least one direct discovery set comprises a list of end WTRU user information IDs of end WTRUs, wherein the WTRU announces itself as an end WTRU by including its end WTRU user information ID in the at least one direct discovery set in the second message.

12. The WTRU of claim 11, wherein the WTRU is associated with a WTRU-to-WTRU relay user information identification (ID) as a relay WTRU and wherein the WTRU is associated with an end WTRU user information ID as an end WTRU.

13. The WTRU of claim 11, wherein:
the transmitter is further configured to send capability information to a network node, wherein the capability information indicates a capability for the WTRU to perform as a WTRU-to-WTRU relay and an end WTRU; and
the receiver is further configured to receive the hybrid node configuration information in response to sending the capability information.

14. The WTRU of claim 11, wherein the at least one direct discovery set is protected based on direct discovery security materials associated with a ProSe direct discovery service for restricted ProSe direct discovery.

15. The WTRU of claim 11, wherein the first message is a first WTRU-to-WTRU relay discovery announcement message, and wherein the second message is a second WTRU-to-WTRU relay discovery announcement message.

16. The WTRU of claim 11, wherein the WTRU is provisioned with direct discovery security materials associated with a ProSe direct discovery service for restricted ProSe direct discovery and wherein the processor is further configured to process the at least one direct discovery set using the direct discovery security materials.

17. The WTRU of claim 11, wherein the WTRU provides, for a destination end WTRU in the direct discovery routing table: a user information ID of the destination end WTRU, a source layer-2 ID associated with the destination end WTRU, a number of hops to the destination end WTRU, and a next hops routing information, wherein the next hops routing information is set to the previous hops routing information in reverse order.

18. The WTRU of claim 11, wherein the previous hops routing information comprises a sequence of user information IDs of WTRU-to-WTRU relays associated with an announcing end UE accumulated hop by hop from a closest previous end WTRU when propagating a WTRU-to-WTRU relay discovery message, wherein a closest previous end WTRU is an intermediate hybrid WTRU or the announcing end WTRU.

19. The WTRU of claim 11, wherein the processor is further configured to update a route to an end WTRU in the direct discovery routing table based on a minimum hop count value or a channel quality of the received first message.

20. The WTRU of claim 11, wherein the WTRU is a hybrid WTRU, wherein the hybrid WTRU performs as an End WTRU and a WTRU-to-WTRU relay.
